(19) United States
(12) Patent Application Publication
(10) Pub. No.: US 2026/0287381 A1
(43) Pub. Date: Sep. 24, 2026

(54) SYSTEM

(71) Applicant: SoftBank Group Corp., Tokyo (JP)

(72) Inventor: Rumi IKEDA, Tokyo (JP)

(73) Assignee: SoftBank Group Corp., Tokyo (JP)

(21) Appl. No.: 19/564,291

(22) Filed: Mar. 12, 2026

(30) Foreign Application Priority Data
Mar. 19, 2025 (JP) 2025-045007

(51) Int. Cl. G01C 21/36; G10L 25/63

(52) U.S. Cl. CPC G01C 21/3641; G10L 25/63

(57) ABSTRACT

A system includes a processor that is configured to manage information of items registered by a user, the items including at least clothing, footwear, bags, and accessories, receive weather forecast information as input, analyze an emotional state of the user, use a generative artificial intelligence model to propose an outfit suitable for a weather condition, a situation, and the emotional state of the user, based on the received weather forecast information, the item information registered by the user, and the analyzed emotional state of the user, and notify and display the proposed outfit on a terminal of the user.

### CROSS-REFERENCE TO RELATED APPLICATION

This application is based on and claims priority under 35 USC 119 from Japanese Patent Application No. 2025-045007 filed on Mar. 19, 2025, the disclosure of which is incorporated by reference herein.

### BACKGROUND

### Technical Field

The present disclosure relates to a system.

### Related Art

Japanese Patent Application Laid-Open (JP-A) No. 2022-180282 discloses a persona chatbot control method executed by at least one processor. The method includes steps of: receiving a user utterance, adding the user utterance to a prompt including a description of a chatbot character and an associated instruction sentence, encoding the prompt, and inputting the encoded prompt to a language model to generate a chatbot utterance responding to the user utterance.

Conventional outfit recommendation systems typically rely on static rules, simple weather information, or general fashion trends, and do not sufficiently take into account a user's dynamically changing emotional state, individual style preferences, and real-time situational context. As a result, the proposed outfits often lack psychological comfort and personal relevance, and the user may feel that the suggestions are impersonal or inappropriate for the user's mood. Furthermore, although some systems can reference weather or seasonal data, they generally do not integrate deep personalization based on learned user preferences with generative artificial intelligence models, and they do not efficiently support the process of complementing missing items through purchase links or assisting in locating items within a physical store. This leads to a fragmented user experience in which the user must separately consider weather, mood, style, and shopping behavior. Therefore, there is a need for a system that can comprehensively manage user-registered items, interpret the user's emotional state, utilize generative artificial intelligence to propose outfits that are optimized for weather, situation, and emotion, and additionally support individualized styling, seasonal and trend-aware proposals, and seamless guidance for obtaining necessary items.

### SUMMARY

In order to solve the above-described problems, the present invention provides a system comprising a processor, wherein the processor is configured to manage information of items registered by a user, the items including at least clothing, footwear, bags, and accessories, receive weather forecast information as input, analyze an emotional state of the user, use a generative artificial intelligence model to propose an outfit suitable for a weather condition, a situation, and the emotional state of the user, based on the received weather forecast information, the item information registered by the user, and the analyzed emotional state of the user, and notify and display the proposed outfit on a terminal of the user. The processor is further configured to learn a preferred style of the user and generate a prompt for instructing the generative artificial intelligence model to perform an individualized outfit proposal based on the preferred style of the user. In addition, the processor is configured to generate a prompt for instructing the generative artificial intelligence model to perform an outfit proposal according to at least one of a season and a fashion trend, generate a purchase link for an item required for the outfit proposal, and provide map information indicating a location of the item within a store based on location information of the user. By these means, the system can provide outfit proposals that reflect the user's emotional state, personal preferences, and environmental conditions, while also enabling the user to efficiently acquire missing items and locate them in physical stores.

The term “processor” refers to one or more hardware circuits, computing units, or processing devices, such as a central processing unit (CPU), graphics processing unit (GPU), application-specific integrated circuit (ASIC), or system-on-chip (SoC), that execute instructions to perform the functions described in the present specification and claims. The term “item” refers to a physical article that can be worn or carried by a user, including at least clothing, footwear, bags, and accessories, and that is registered and managed by the system as part of the user's wardrobe information.

The term “clothing” refers to garments worn on the body, such as shirts, blouses, dresses, jackets, coats, pants, skirts, and similar wearable textiles.

The term “footwear” refers to items worn on the feet, including but not limited to shoes, boots, sandals, and sneakers.

The term “bag” refers to containers carried by a user for holding personal items, including but not limited to handbags, backpacks, shoulder bags, tote bags, and briefcases.

The term “accessories” refers to supplementary wearable items that complement clothing or footwear, such as hats, scarves, gloves, belts, jewelry, watches, ties, and similar adornments.

The term “weather forecast information” refers to data representing predicted atmospheric and environmental conditions for a given location and time period, including at least one of temperature, precipitation, humidity, wind, and general weather conditions such as sunny, cloudy, rainy, or snowy.

The term “emotional state” refers to a psychological condition or mood of the user, such as happiness, sadness, calmness, excitement, stress, or other affective states, which is inferred or analyzed by the system for use in outfit proposal.

The term “analyze an emotional state of the user” refers to a process in which the processor evaluates input data related to the user, such as textual input, voice input, biometric signals, behavioral logs, or interaction history, to infer or classify the user's current or recent emotional condition.

The term “generative artificial intelligence model” refers to a machine learning model, such as a neural network-based model including a large language model or a generative image model, that is capable of generating new output data, including at least outfit proposals, based on input conditions, prompts, and learned parameters.

The term “prompt” refers to a structured input, instruction, or query supplied to the generative artificial intelligence model by the processor, the input specifying conditions, constraints, user preferences, or objectives to guide the generation of an outfit proposal or other outputs.

The term “outfit proposal” refers to a set of one or more items selected or generated by the system as a recommended combination to be worn by the user, taking into account at least weather conditions, situation, emotional state, user preferences, season, and fashion trends. The term “situation” refers to a contextual condition or use case in which the user intends to wear an outfit, including at least one of work, business, casual outing, formal event, date, party, travel, or sports activity.

The term “preferred style of the user” refers to a set of characteristics of clothing and accessories favored by the user, such as colors, silhouettes, materials, brands, degrees of formality, and patterns, which are learned by the system from user behavior, feedback, and interaction history.

The term “individualized outfit proposal” refers to an outfit proposal that is specifically tailored to a particular user based on the user's preferred style, historical choices, feedback, and other user-specific data, rather than being a generic or non-personalized suggestion. The term “season” refers to a time period classified according to climate or calendar, such as spring, summer, autumn, or winter, which influences appropriate materials, layering, and colors for outfit proposals.

The term “fashion trend” refers to a style, color, pattern, silhouette, or combination of items that is currently popular or emerging in fashion, as determined from external data sources, curated content, or internal rules, and which is used to bias or guide outfit proposals. The term “purchase link” refers to an electronic link, such as a URL or deep link, that directs the user to an online resource or e-commerce page where an item required for an outfit proposal can be viewed and purchased.

The term “location information of the user” refers to data identifying the geographical position of the user, such as GPS coordinates, a store identifier, or other positional data, which can be used to determine the user's presence in or near a specific store.

The term “map information” refers to digital data representing a spatial layout, such as a floor plan or indoor map of a store, including positional indications that enable the user to identify the location of a specific item within the store.

The term “terminal of the user” refers to an electronic device operated by the user, such as a smartphone, tablet, personal computer, or wearable device, that is capable of communicating with the system, receiving notifications, and displaying proposed outfits and related information.

### BRIEF DESCRIPTION OF THE DRAWINGS

Exemplary embodiments of the present disclosure will be described in detail based on the following figures, wherein:

FIG. 1 is a schematic diagram illustrating an example of a configuration of a data processing system according to a first exemplary embodiment;

FIG. 2 is a schematic diagram illustrating an example of relevant functions of a data processing device and a smart device according to the first exemplary embodiment;

FIG. 3 is a schematic diagram illustrating an example of a configuration of a data processing system according to a second exemplary embodiment;

FIG. 4 is a schematic diagram illustrating an example of relevant functions of a data processing device and smart glasses according to the second exemplary embodiment;

FIG. 5 is a schematic diagram illustrating an example of a configuration of a data processing system according to a third exemplary embodiment;

FIG. 6 is a schematic diagram illustrating an example of relevant functions of a data processing device and a headset-type terminal according to the third exemplary embodiment;

FIG. 7 is a schematic diagram illustrating an example of a configuration of a data processing system according to a fourth exemplary embodiment;

FIG. 8 is a schematic diagram illustrating an example of relevant functions of a data processing device and a robot according to the fourth exemplary embodiment;

FIG. 9 illustrates an emotion map mapping plural emotions;

FIG. 10 illustrates an emotion map mapping plural emotions;

FIG. 11 is a sequence diagram showing the flow of data processing system processing in Example 1;

FIG. 12 is a sequence diagram showing the flow of data processing system processing in Application Example 1;

FIG. 13 is a sequence diagram showing the flow of data processing system processing in Example 2; and

FIG. 14 is a sequence diagram showing the flow of data processing system processing in Application Example 2.

### DETAILED DESCRIPTION

Description follows regarding an example of exemplary embodiments of a system according to technology disclosed herein, with reference to the appended drawings.

First, explanation follows regarding terminology employed in the following description.

In the following exemplary embodiments, a reference-numeral-appended processor (hereinafter simply referred to as “processor”) may be implemented by a single computation unit, and may be implemented by a combination of plural computation units. The processor may be implemented by a single type of computation unit, or may be implemented by a combination of plural types of computation units. Examples of computation unit include a central processing unit (CPU), a graphics processing unit (GPU), a general-purpose computing on graphics processing units (GPGPU), an accelerated processing unit (APU), and the like.

In the following exemplary embodiments, random access memory (RAM) appended with a reference numeral is memory temporarily stored with information, and is employed as working memory by a processor.

In the following exemplary embodiments, reference-numeral-appended storage is a single or plural non-volatile storage devices for storing various programs and various parameters and the like. Examples of non-volatile storage devices include flash memory (such as a solid state drive (SSD)), a magnetic disk (for example, a hard disk), magnetic tape, and the like.

In the following exemplary embodiments, a reference-numeral-appended communication interface (I/F) is an interface including a communication processor and an antenna or the like. The communication I/F has the role of communicating between plural computers. An example of a communication standard applied for the communication I/F is a wireless communication standard, such as a Fifth Generation Mobile Communication System (5G), Wi-Fi (registered trademark), Bluetooth (registered trademark), and the like.

In the following exemplary embodiments “A and/or B” has the same definition as “at least one out of A or B”. Namely, “A and/or B” may mean A alone, may mean B alone, or may mean a combination of A and B. Moreover, similar logic to “A and/or B” is applied when “and/or” is employed to link three or more items in the present specification.

### First Exemplary Embodiment

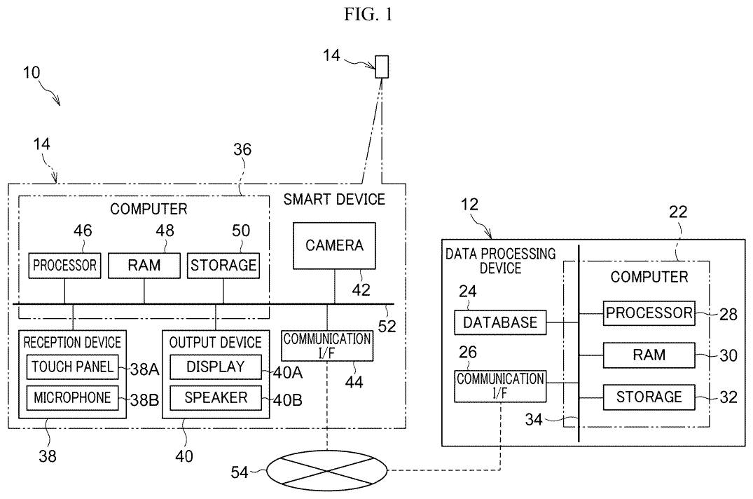

FIG. 1 illustrates an example of a configuration of a data processing system 10 according to a first exemplary embodiment.

As illustrated in FIG. 1, the data processing system 10 includes a data processing device 12 and a smart device 14. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart device 14 includes a computer 36, a reception device 38, an output device 40, a camera 42, and a communication I/F 44. The computer 36 includes a processor 46, RAM 48, and storage 50. The processor 46, the RAM 48, and the storage 50 are connected to a bus 52. The reception device 38, the output device 40, the camera 42, and the communication I/F 44 are also connected to the bus 52.

The reception device 38 includes a touch panel 38A, a microphone 38B, and the like for receiving user input. The touch panel 38A receives user input from contact of a pointer (for example, a pen, a finger, or the like) by detecting contact of the pointer. The microphone 38B receives spoken user input by detecting speech of the user. A control unit 46A in the processor 46 transmits data representing the user input received by the touch panel 38A and the microphone 38B to the data processing device 12. A specific processing unit 290 in the data processing device 12 acquires the data indicating the user input.

The output device 40 includes a display 40A, a speaker 40B, and the like for presenting data to a user 20 by outputting the data in an expression format perceivable by the user 20 (for example, audio and/or text). The display 40A displays visual information such as text, images, or the like under instruction from the processor 46. The speaker 40B outputs audio under instruction from the processor 46. The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like.

The communication I/F 44 is connected to the network 54. The communication I/F 44 and the communication I/F 26 perform the role of exchanging various information between the processor 46 and the processor 28 over the network 54.

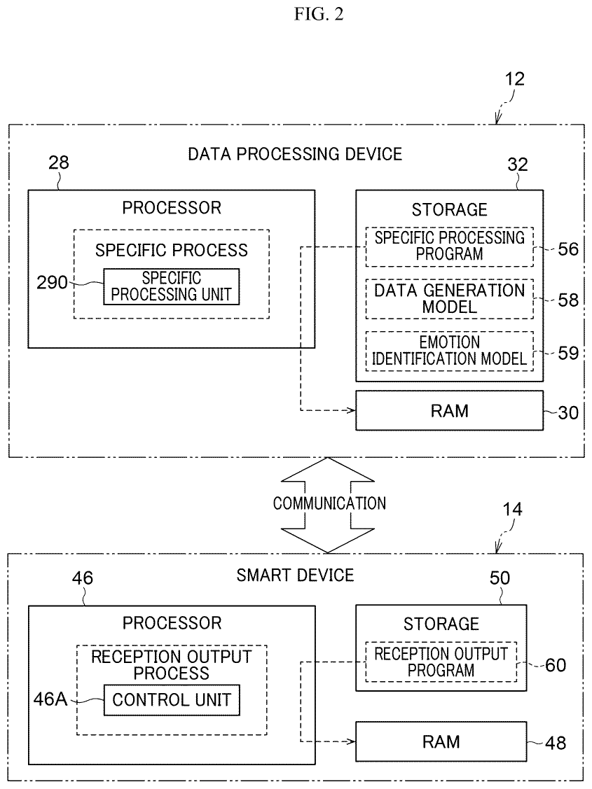

FIG. 2 illustrates an example of relevant functions of the data processing device 12 and the smart device 14.

As illustrated in FIG. 2, specific processing is performed by the processor 28 in the data processing device 12. A specific processing program 56 is stored in the storage 32. The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

A data generation model 58 and an emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart device 14. A reception and output program 60 is stored in the storage 50. The reception and output program 60 is employed by the data processing system 10 in combination with the specific processing program 56. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48. Note that a configuration may be adopted in which a similar data generation model and emotion identification model to the data generation model 58 and the emotion identification model 59 are included in the smart device 14, and these models are used to perform similar processing to the specific processing unit 290. The reception and output program is implemented by the processor 46 operating as the control unit 46A according to the reception and output program 60 executed in the RAM 48.

Note that devices other than the data processing device 12 may include the data generation model 58. For example, a server device (for example, a generation server) may include the data generation model 58. In such cases, the data processing device 12 performs communication with the server device including the data generation model 58 to obtain a processing result (prediction result or the like) obtained using the data generation model 58. The data processing device 12 may be a server device, and may be a terminal device owned by the user (for example, a mobile phone, a robot, a home electrical appliance, or the like). Next, description follows regarding an example of processing by the data processing system 10 according to the first exemplary embodiment.

### Example 1

Description follows regarding a flow of the specific processing in an Example 1. The units of the system described below are implemented by the data processing device 12 and the smart device 14. The data processing device 12 is called a “server” and the smart device 14 is called a “terminal”.

Conventional wardrobe management and outfit recommendation systems typically rely on fixed rule sets, static matching tables, or simple filtering operations over item attributes. Such systems are often implemented as applications that merely retrieve records from a database based on category or color fields and then display the retrieved items. As a result, these systems are limited to superficial coordination suggestions that do not fully exploit the computing resources of modern information processing environments.

In particular, existing systems exhibit several technical shortcomings from a computer-technology perspective. First, item data, user preference data, contextual information such as weather information and user emotional state, and generative artificial intelligence outputs are handled in separate, loosely coupled pipelines. This fragmented design forces the processor and storage subsystem to repeatedly perform ad-hoc data transformations and redundant queries, resulting in inefficient use of memory and processor cycles, increased network traffic between a server and a user terminal, and higher latency in generating coordination results.

Second, known systems do not provide a standardized mechanism for constructing and managing prompt sentences and internal control prompts supplied to a generative AI model together with structured wardrobe data stored in a relational database. Without a systematic way to integrate structured attribute data (such as normalized category, color, and material fields) with natural language prompt sentences and contextual signals (such as weather forecasts and emotional state estimations), the interaction with the generative AI model becomes opaque and inefficient. This leads to inconsistent outputs, additional post-processing load on the processor, and increased memory consumption due to the need to maintain multiple intermediate representations.

Third, conventional architectures typically treat generative AI as an external, monolithic component that simply receives free-form text and returns free-form text. The server-side processor thus cannot effectively leverage existing structured item records when issuing queries to the AI model, nor can it robustly map generated natural-language coordination proposals back to specific stored item records. Consequently, the storage device is under-utilized as a source of structured constraints and identifiers, and the processor must perform error-prone text parsing after each response, adding computational overhead and degrading scalability when supporting many users.

Fourth, existing systems do not provide an integrated data flow in which season, trend, position, and sales information are combined with user wardrobe data and generative AI outputs to automatically generate purchase links and in-store location maps. In current implementations, such information is either added manually or via separate services, requiring additional network calls and separate user interface flows. This fragmented handling of ancillary information prevents the processor from optimizing the overall sequence of database access, AI inference, and content delivery to the user terminal.

Accordingly, there is a need for an improved computer-implemented system and method that (i) systematically structures item and context data in a relational storage device, (ii) tightly integrates such structured data with prompt sentences and internal prompts supplied to a generative AI model, (iii) reduces redundant computation and network communication by associating AI-generated coordination elements directly with stored item identifiers and images, and (iv) automatically generates purchasing and navigation information in a unified processing pipeline. Such an improvement in the cooperation between the processor, the storage device, the user terminal, and the generative AI model can enhance the efficiency, reliability, and scalability of wardrobe coordination services implemented on general-purpose computing hardware.

The specific processing by the specific processing unit 290 of the data processing device 12 in Example 1 is realized by the following means.

The present invention provides a server comprising a processor, a storage device having a relational database management function, and an interface for communication with a user terminal, wherein the processor is configured to acquire, from the user terminal, attribute information and image information regarding articles possessed by a user, structure the acquired information as normalized structured data including at least category, color, material, and mark attributes, and store the structured data in the storage device in a plurality of storage areas divided by attribute; to receive, from the user terminal, command information including a natural language prompt sentence, construct input information for a generative AI model by combining the prompt sentence with the structured data stored in the storage device and further with contextual signals including weather forecast information and user emotional state information, and supply the constructed input information to the generative AI model so as to cause the generative AI model to generate a clothing coordination proposal; to generate and supply internal prompt sentences to the generative AI model based on past user selection histories and evaluation information so that the generative AI model learns user preference and usage tendencies and performs personalized inference; to additionally obtain season information, trend information, position information, and sales information, generate internal prompt sentences that instruct the generative AI model to output purchase information, route information, and layout information for articles not possessed by the user but included in the clothing coordination proposal, and receive, from the generative AI model, corresponding enriched coordination results; and to analyze the clothing coordination proposal received from the generative AI model, associate article types and attribute descriptions contained in the proposal with the structured data stored in the storage device so as to identify concrete stored articles, and transmit to the user terminal display data including identifiers and images of the identified stored articles together with link information for purchase and map information for in-facility locations of non-owned articles. This enables an integrated computer-implemented pipeline in which structured wardrobe data, contextual signals, and generative AI model interactions are managed in a unified manner, thereby reducing redundant data transformations and network round-trips, improving processor and memory utilization when generating personalized clothing coordination proposals, and allowing the server to efficiently output coordination results that are directly bound to stored item records and associated purchasing and navigation information.

The term “processor” refers to one or more hardware computation units, such as a central processing unit or an execution core, that execute machine-readable instructions to perform data processing operations described in the present specification.

The term “storage device” refers to one or more non-transitory computer-readable media, such as semiconductor memory, magnetic storage, or optical storage, that store structured data, program code, and intermediate processing results accessible by the processor.

The term “user terminal” refers to an electronic apparatus operated by a user, such as a mobile communication device, a portable information processing device, or a stationary information processing device, that provides input to and receives output from the processor via a communication interface.

The term “article” refers to any tangible personal item subject to wardrobe management, including but not limited to garments, footwear, bags, and accessories, that is registered and managed as an item record in the system.

The term “attribute information” refers to structured descriptive data associated with an article, including at least information indicating a category of the article, a color of the article, a material of the article, and a mark or brand related to the article.

The term “image information” refers to digital image data representing visual information of an article, acquired by an imaging device or obtained from another source, and stored in association with the attribute information of the article.

The term “structured data” refers to data that is organized into a predefined schema or format, such as records with explicit fields for category, color, material, and mark, enabling storage and retrieval by a relational database management function.

The term “category information” refers to attribute information that classifies an article into a functional or stylistic group, such as a top, bottom, outerwear, footwear, or accessory category.

The term “color information” refers to attribute information that indicates a hue, tone, or color designation of an article, represented as a textual label, a code, or a numeric value.

The term “material information” refers to attribute information that indicates a primary constituent substance of an article, such as a type of textile, leather, synthetic material, or other composition.

The term “mark information” refers to attribute information that indicates a sign, label, brand, trademark, or equivalent identification associated with an article.

The term “relational database management function” refers to functionality for storing, organizing, and retrieving structured data in accordance with a relational data model, using tables, keys, and relational operations such as selection and join.

The term “storage area” refers to a logical or physical subdivision of the storage device, such as a table, partition, or segment, used to store structured data according to one or more attributes.

The term “search condition” refers to one or more constraints or filter criteria, designated by the user through the user terminal, that are used by the processor to select a subset of structured data stored in the storage device.

The term “presentation data” refers to data formatted for display or output on a user terminal, including selected attribute information, image information, and coordination proposals, in a form suitable for visualization or interaction by the user.

The term “command information” refers to data transmitted from a user terminal to the processor that specifies an operation request, and that includes at least one natural language prompt sentence used to request generation of a coordination proposal.

The term “prompt sentence” refers to a natural language sentence or sequence of sentences supplied to a generative AI model as part of input information, instructing the model to generate an output such as a clothing coordination proposal.

The term “generative artificial intelligence model” refers to a machine-learned model, such as a neural network-based language model, that generates text or other content in response to input information including prompt sentences and structured data.

The term “inference processing” refers to a computation performed by a generative artificial intelligence model or other machine-learned model to produce an output, such as a clothing coordination proposal, based on provided input information.

The term “clothing coordination proposal” refers to information generated by the system that specifies one or more combinations of articles suitable to be worn together, including, for example, combinations of tops, bottoms, outerwear, footwear, and accessories.

The term “display data” refers to data output by the processor and formatted to be rendered by a display device of the user terminal, including text, identifiers, and images associated with articles and coordination proposals.

The term “weather forecast information” refers to data indicative of predicted atmospheric conditions for a given time period and location, such as temperature, precipitation, and cloud cover, acquired from a weather information acquisition device or service.

The term “user emotional state information” refers to data indicating an estimated emotional or affective condition of the user, such as mood or stress level, acquired from a user state estimation device or algorithm.

The term “past selection history” refers to data representing articles or coordination proposals previously selected, worn, or confirmed by the user, as recorded and stored by the system.

The term “evaluation information” refers to data indicating a user's explicit or implicit evaluation of articles or coordination proposals, such as ratings, likes, dislikes, or usage frequency.

The term “feature information” refers to data learned or derived by a machine-learning process that characterizes a preference tendency or a usage tendency of a user based on past selection history and evaluation information.

The term “preference tendency” refers to a pattern of user selections or evaluations that indicates favored attributes or combinations of attributes, such as preferred colors, materials, categories, or styles.

The term “usage tendency” refers to a pattern of user behavior indicating how often, under which contexts, or in which combinations certain articles are selected or used.

The term “internal prompt sentence” refers to a prompt sentence automatically generated by the processor, not directly input by the user, and supplied to a generative AI model in order to control or personalize the model's inference behavior.

The term “season information” refers to data indicating a time-of-year context, such as season or month, that can affect suitability of articles or coordination proposals.

The term “trend information” refers to data indicating current or emerging fashion tendencies or popular styles, obtained from an external source or derived from aggregated usage data.

The term “position information” refers to data that specifies a geographic location or a location within a facility, such as coordinates, floor identifiers, or area identifiers.

The term “sales information” refers to data associated with availability, price, promotion, or vendor details of articles that can be purchased by the user.

The term “purchase information” refers to data used to facilitate acquisition of an article, including vendor identification, item identification, pricing, and transactional links.

The term “route information” refers to data that describes a path or sequence of locations for reaching a physical or virtual location where an article is available, including, for example, in-store navigation routes.

The term “layout information” refers to data indicative of an arrangement or placement of articles within a facility, such as sections, shelves, or display areas.

The term “link information” refers to data representing a network-accessible reference, such as a uniform resource locator or equivalent identifier, that enables the user terminal to access purchase information or related resources.

The term “map information” refers to data used to render a graphical or schematic representation of a facility or area, indicating positions of articles or relevant locations for navigation purposes.

The term “data interchange format” refers to a syntactic structure, such as a hierarchical or tabular encoding, that defines how data is serialized for transmission between the user terminal and the processor.

The term “identifier information” refers to data that uniquely distinguishes an article or record within the system, such as an item ID or record key, used for retrieval and association processing.

In one embodiment, a server cooperates with a terminal and a user to implement a wardrobe coordination system using a generative AI model and structured wardrobe data.

### A. Hardware and Software Configuration

The server uses general-purpose computer hardware, for example a rack-mounted x86-based server including one or more multi-core processors, main memory, and non-volatile storage such as solid-state drives. The server executes a server operating system such as a general-purpose UNIX-like operating system, and runs a web server process such as an HTTP reverse proxy combined with an application framework such as a server-side scripting or runtime environment. The server further executes a relational database management system such as a structured query language (SQL) database on the storage device, where the database provides table-based storage, indexing, transaction management, and query optimization.

The terminal uses a mobile information processing device such as a smartphone or tablet including a processor, memory, a built-in camera, a display, and a wireless communication interface. The terminal executes a mobile operating system such as a smartphone OS and runs a dedicated native application. The terminal uses an OS-level networking stack to communicate with the server via an encrypted transport protocol over a packet-switched network.

The server accesses a generative AI model over a communication network. In one embodiment, the generative AI model runs on an external computation platform and is provided over an application programming interface. In another embodiment, the generative AI model is deployed locally on the same hardware or on a separate computing node connected via a local network. The generative AI model uses a transformer-based neural network architecture with multiple attention layers, feed-forward layers, and learned token embeddings. The model receives tokenized input sequences that encode prompt sentences, structured attribute summaries, and contextual features, and outputs tokenized text sequences representing clothing coordination proposals and auxiliary information.

### B. Data Structures and Database Schema

The server stores wardrobe-related information in the relational database as structured data. The server defines an items table with columns including at least: an item identifier, a user identifier, category information, color information, material information, mark information, optional style tags, and an image reference such as a file path or a content identifier. The server assigns a primary key to the item identifier and defines indexes on the user identifier, category information, color information, and material information. The server thereby enables efficient selection, projection, and join operations over the wardrobe data. The server stores user preference and behavior information in additional tables. The server defines a user_history table containing records of outfit selections and usage events, with fields such as user identifier, item identifiers used together, timestamps, and context attributes such as temperature range or occasion. The server defines a user_feedback table containing evaluation information such as numeric ratings, categorical feedback, or binary like/dislike flags. The server further stores metadata related to seasonal context, trend context, and sales context in tables such as season_context, trend_context, and product_offers.

The server uses a normalized schema to avoid redundancy, with foreign key relationships between user records, item records, and context records. The server employs indices on commonly used query fields to reduce query latency. The server caches frequently accessed item attributes and embeddings in memory to reduce database load during high-frequency AI interactions.

### C. Image Acquisition and Attribute Structuring

The terminal uses the camera hardware and OS camera API to capture images of articles such as garments, footwear, bags, and accessories. The terminal encodes the captured image into a digital format such as a compressed image file and stores it temporarily in local storage. The terminal requests signed upload URLs or equivalent identifiers from the server, and uploads the image to a server-managed storage location or to an external object store.

The terminal displays a form that includes input widgets for category information, color information, material information, and mark information. The user selects or enters attribute values using graphical interface elements. The terminal validates that mandatory fields are present and converts the attribute values into a normalized form, for example mapping category labels to canonical codes and converting color names to predefined tokens.

The terminal assembles a structured data record in a hierarchical representation including fields for user identifier, normalized category information, normalized color information, normalized material information, normalized mark information, and the uploaded image reference. The terminal transmits this structured data to the server via a standardized data interchange format such as a text-based hierarchical data format.

The server receives the structured data and converts it into database records. The server applies additional normalization rules, such as mapping synonyms (for example, “denim” and “jean fabric”) to a shared material code and mapping similar color terms to a common color group. The server performs referential integrity checks, inserts the item record into the items table, and stores the image reference in association with the item identifier.

### D. Construction and Use of Prompt Sentences

The user uses the terminal to request coordination proposals by typing natural language prompt sentences into a text input field. The terminal collects the prompt sentence as a text string and may additionally allow the user to select particular items from a list. The terminal transmits the prompt sentence and selected item identifiers to the server.

Example prompt sentences include:

“Please suggest bottoms that match my red tops.”

“Suggest three outfits using my blue jeans for a weekend outing.” “Given that it is rainy and around 10° C., propose a practical and stylish outfit from my registered coats and boots.”

“Propose a business-casual outfit using my navy blazer and black shoes.”

“Suggest tops and accessories that match my red dress for an evening party.”

The server receives the prompt sentence and retrieves relevant wardrobe records from the database, such as all tops of a specified color, or all items tagged as suitable for a particular season. The server summarizes the structured wardrobe information into a textual representation suitable for use with the generative AI model. The server uses a deterministic formatting scheme that lists each item with a stable identifier, category, color, material, and optional tags. The server thus produces a combined input context that includes: a system-side instruction segment, a structured wardrobe segment, and a user prompt segment. The server also generates internal prompt sentences that are not directly visible to the user. The server constructs these internal prompt sentences based on past user selection history and evaluation information stored in the database. For example, the server encodes user-specific style preferences such as “user tends to prefer dark neutral colors for workdays” or “user often selects sneakers for casual outings” in a descriptive format. The server includes these internal prompt sentences in the input to the generative AI model, thereby guiding the inference process toward personalized outputs.

### E. Generative AI Model Architecture and Training

The server uses a generative AI model that is implemented as a multi-layer transformer neural network comprising self-attention layers, feed-forward layers, and normalization layers. The model operates on tokenized sequences, where each input token may represent a subword unit, a control token for segment boundaries, or a special token for marking item identifiers. The model uses embeddings to project tokens into a continuous vector space, and uses positional encodings to preserve word order.

The server trains or fine-tunes the generative AI model on a corpus that includes wardrobe descriptions, outfit combinations, fashion commentary, and user-interaction logs. The server uses supervised learning where input sequences include wardrobe contexts and prompt sentences, and target sequences include desired coordination proposals. The server defines a loss function such as cross-entropy loss over the model's predicted token distributions and uses gradient-based optimization such as stochastic gradient descent or adaptive moment estimation to update model weights. The server employs regularization techniques such as dropout and weight decay to improve generalization, and may use data augmentation by paraphrasing prompt sentences or sampling alternative but equivalent wardrobe descriptions. The server additionally trains the generative AI model or an auxiliary preference model using user-specific histories. The server constructs training examples where an input sequence includes wardrobe context plus a prompt sentence and an internal prompt describing user preferences, and the target sequence reflects coordination proposals that the user previously accepted or highly rated. The server uses this training to adapt the model's internal representations such that the model implicitly encodes feature information reflecting user-specific preference tendencies and usage tendencies. The server thereby causes the model to generate more accurate and user-tailored outputs for similar future inputs.

### F. Inference Processing and Mapping to Stored Items

During inference, the server constructs a composite input sequence that includes the structured wardrobe summary, internal prompt sentences, context signals such as weather and season, and the user's prompt sentence. The server tokenizes this sequence, applies model-specific preprocessing such as truncation and padding, and feeds the token sequence to the generative AI model. The model processes the sequence layer by layer, computing attention-weighted combinations of token embeddings and generating logits over the output vocabulary. The model decodes a candidate output sequence representing one or more clothing coordination proposals.

The server receives the decoded text and executes a parsing routine to interpret the proposal. The server uses rule-based pattern matching or a lightweight classifier to detect references to item types, colors, and materials mentioned in the generated text. The server then queries the relational database using these detected attributes and the stored item identifiers to match the proposed items to actual records in the items table. For example, if the proposal includes “dark blue jeans,” the server searches for bottoms with a blue color group and denim material, and matches the closest stored item based on a similarity score.

The server uses a non-trivial association algorithm that considers multiple attributes and context weights. The server can assign higher weights to attributes that are more salient for item discrimination, such as category and material, and lower weights to attributes that are less critical, such as secondary color tags. By computing an attribute-weighted distance between the generated description and each candidate item record, the server selects the item with minimum distance as the most appropriate mapping. This procedure reduces ambiguity and improves the precision of item selection relative to naïve keyword matching.

The server then constructs display data that includes the generated coordination narrative, the identifiers of matched wardrobe items, and thumbnail image references. For non-owned items suggested by the model, the server uses the product_offers and layout-related tables to retrieve sales information and position information to create purchase links and map overlays. G. Integration of contextual information and technical effects

The server integrates real-world contextual information, such as weather forecast information and the user's estimated emotional state, by retrieving these signals from external or internal modules. The server converts numeric temperature values, precipitation probabilities, and weather categories into feature tokens or textual descriptors that are injected into the internal prompt sentences. The server also converts emotional state values into descriptive cues, such as “user feels tired” or “user is in a cheerful mood,” formatted as part of the control segment supplied to the generative AI model.

By embedding this structured contextual information into the same sequence as the wardrobe data and internal prompts, the server causes the generative AI model to condition its attention on these tokens when generating proposals. This unified representation enables the model to jointly consider wardrobe availability, environmental conditions, and user state without requiring separate rule engines. As a result, the server reduces the amount of post-hoc filtering and manual rule application required on the server side, improving throughput and reducing latency.

The server architecture yields several technical effects:

The server reduces the number of network round-trips between the server and the generative AI platform by constructing a single, rich prompt sequence that includes wardrobe data, preference data, and contextual data. This reduces overall communication overhead and leads to faster response times.

The server improves memory utilization and cache efficiency by storing wardrobe data in a normalized relational schema with indexed fields, so that attribute-based searches and mapping operations are performed via optimized SQL queries instead of ad-hoc scanning of unstructured text.

The server improves accuracy of coordination proposals as perceived by the user by training the generative AI model with internal prompts based on user-specific feature information and by using multi-attribute similarity matching to map generated descriptions to stored items.

The server reduces computational overhead for text parsing by using structured item identifiers directly in the wardrobe context segment of the input sequence, encouraging the generative AI model to refer to items by explicit identifiers. When the model outputs such identifiers or fixed patterns, the server can resolve them using efficient table lookups rather than complex natural language processing.

The server achieves technical improvements over simple automation of human decision-making by designing a coordinated pipeline in which database structure, model architecture, internal prompts, and mapping algorithms are optimized together to reduce redundant operations and to enable new capabilities, such as real-time coordination proposals that are tightly bound to a user's actual inventory.

### H. Controlled Internal Prompting and Non-Conventional AI Usage

The server uses internal prompt sentences not only to inject user preferences but also to specify constraints regarding computational behavior of the generative AI model. For example, the server defines internal prompts that instruct the model to output a fixed number of proposals, to reference items using specific identifier formats, or to exclude certain categories for safety or policy reasons. These internal prompts encode rules and system-level constraints that are difficult for a human operator to enforce manually and are not part of the user-visible prompt sentences. By changing internal prompts based on learned feature information, the server dynamically modifies how the model allocates attention and sequence length among various segments.

This controlled prompting constitutes a non-conventional usage of a generative AI model in that the server exploits the model's internal attention patterns and sequence representation to perform constrained generation closely aligned with the system's data schema. The server thereby transforms the generative model from a general text generator into a component that is integrated with structured storage and indexing mechanisms.

### I. Alternative Embodiments and Variations

In one variation, the server incorporates an auxiliary encoder network that transforms structured wardrobe records into dense vector embeddings. The server stores these embeddings in a separate table or vector index and uses them as additional features when constructing the input for the generative AI model. The server can use these embeddings to compute similarity scores between generated descriptions and stored items without repeatedly querying the entire items table, thereby improving scalability.

In another variation, the server deploys the generative AI model locally on dedicated accelerator hardware such as graphics processing units. The server encodes prompt sentences and context tokens on the server, runs batched inference for multiple users simultaneously, and returns batched responses. This configuration reduces dependence on external AI services and allows low-latency, high-throughput recommendations.

In another embodiment, the terminal performs part of the preprocessing for wardrobe descriptions. The terminal may run a lightweight neural model to detect dominant colors or garment types from captured images, and may send both user-entered attributes and model-derived attributes to the server. The server uses these augmented attributes to refine normalization and to improve mapping accuracy during inference.

In a further embodiment, the server periodically retrains or fine-tunes the generative AI model or an auxiliary preference model using newly accumulated user histories and feedback records. The server selects representative samples, computes loss values using a defined objective function, updates model parameters, and redeploys the updated models. This iterative learning process continuously improves alignment between the generated coordination proposals and evolving user preferences while keeping the runtime inference pipeline unchanged.

In each embodiment, the server, the terminal, and the generative AI model are configured so that structured wardrobe data, context signals, and prompt sentences are combined and processed in a coordinated, technically optimized manner. As a result, the system not only automates presentation of outfit suggestions but also improves core computer-implemented operations including data structuring, algorithmic inference control, storage access patterns, and network communication efficiency.

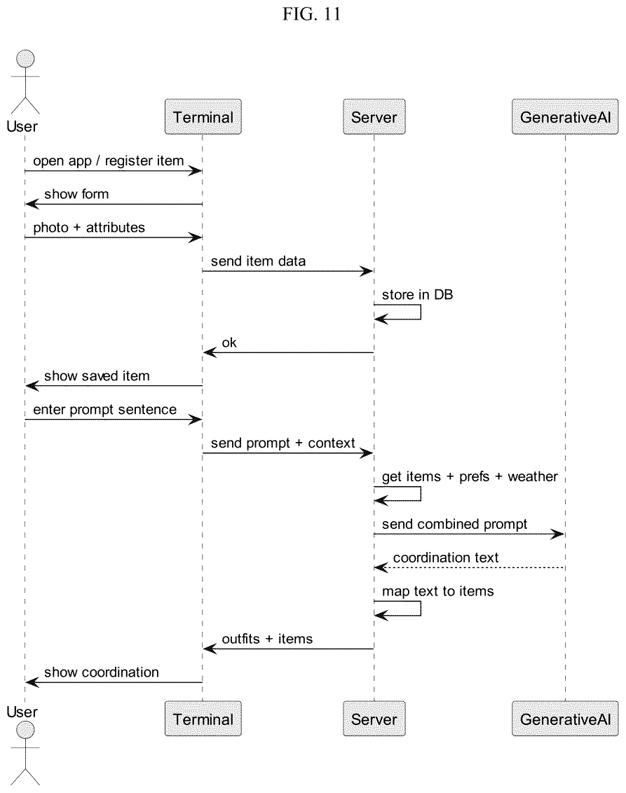

The following describes the processing flow using FIG. 11.

### Step 1:

User operates the terminal to start a dedicated wardrobe application and select an item registration function.

Input: A user action on the terminal's user interface (touch event on an icon or menu).

Output: A registration screen displayed on the terminal.

Terminal loads application resources from local storage, initializes a camera module, a form input module, and a network communication module, and switches the display to a screen that shows controls for capturing an image and entering attribute information.

### Step 2:

User uses the terminal to capture an image of an article or select an existing image.

Input: A camera activation command and the scene in front of the terminal's imaging device, or a selection of an existing image file.

Output: A digital image file or image buffer stored in the terminal.

Terminal invokes an OS camera API, sets resolution and compression parameters, obtains an RGB frame from the imaging sensor, compresses it into a still image format, and stores a reference (file path or URI) in the application's local storage for later upload.

### Step 3:

Terminal displays an attribute input form and acquires attribute information from the user.

Input: The captured image reference and user operations on category, color, material, and mark input controls.

Output: A set of attribute values associated with the image.

Terminal renders input widgets (drop-downs, text fields, color selectors), receives key events and touch events, validates that mandatory fields are not empty, converts selected options to normalized internal codes (for example, mapping “shirt” to a category code and “red” to a standardized color token), and stores these codes in a temporary data structure.

### Step 4:

Terminal generates structured data for the article and prepares transmission to the server.

Input: The image reference and normalized attribute codes (category, color, material, mark) together with a user identifier stored on the terminal.

Output: A structured data object ready for network transmission.

Terminal assembles a hierarchical record including user ID, attribute codes, optional free-text notes, and an image identifier, serializes this record into a text-based interchange format, and creates an HTTP request body containing the serialized record.

### Step 5:

Terminal transmits the structured item data to the server.

Input: The structured data object and network configuration parameters for the server's endpoint.

Output: A network request sent to the server over a transport protocol.

Terminal opens a secure socket, applies an encryption protocol handshake, sets HTTP headers including authentication tokens, attaches the serialized structured data as the message body, and sends a POST request to a registration endpoint of the server.

### Step 6:

Server receives and parses the structured item data.

Input: The HTTP POST request from the terminal containing the serialized structured data. Output: An internal representation of the item record on the server.

Server accepts the incoming request at a web server interface, passes the message body to an application handler, decodes the serialized data back into a structured object, verifies the authentication token, and extracts fields such as user ID, category code, color code, material code, mark code, and image identifier.

### Step 7:

Server normalizes and validates the item attributes.

Input: The parsed item record with raw codes and strings.

Output: A validated and normalized item record ready for storage.

Server checks each field for validity (for example, ensuring that category codes are within allowed values and color codes match predefined sets), maps synonyms or outdated codes to current canonical codes, and, if inconsistencies are detected, applies correction rules or returns an error. This processing uses lookup tables stored in memory, and the server rewrites fields so that they conform to a unified internal schema.

### Step 8:

Server stores the item record in a relational database.

Input: The validated and normalized item record.

Output: A persistent database row including an item identifier.

Server constructs a parameterized SQL INSERT statement referencing columns such as user_id, category, color, material, mark, and image_path, passes the parameters to a database driver, and executes the statement. The database generates a unique item identifier, commits the transaction, and returns the identifier. The server then builds an in-memory object including this identifier.

### Step 9:

Server returns a registration response to the terminal.

Input: The stored item identifier and status of the database operation.

Output: A response message sent to the terminal indicating registration success or failure.

Server constructs a response object with fields such as item_id and status, serializes the object into a text-based format, sets an appropriate HTTP status code, and sends the response back through the network interface to the terminal.

### Step 10:

Terminal updates its local state and confirms registration to the user.

Input: The response message from the server containing the item identifier and status.

Output: An updated local cache and a confirmation display on the terminal.

Terminal parses the response, inserts the new item into a local list of items with its identifier and attributes, triggers a user interface update, and displays a confirmation message along with a thumbnail preview generated from the stored image reference.

### Step 11:

User requests a list of registered items or applies a filter.

Input: A user interaction on a closet or list screen, including optional filter criteria such as category “tops” and color “red.”

Output: A search request to the server.

Terminal captures the filter parameters from UI controls, composes a query object that includes user ID and filter criteria, and prepares a network request to the server's search endpoint.

### Step 12:

Terminal sends a search request and awaits results.

Input: The search query object.

Output: A network message transmitted to the server.

Terminal serializes the query object into a query string or request body, issues an HTTP GET or POST call to the server, and opens a receive buffer to accept the incoming search results.

### Step 13:

Server retrieves matching items from the database.

Input: The search query parameters including user ID and filter conditions.

Output: A list of item records that satisfy the search conditions.

Server converts the filter conditions into a SQL SELECT statement with WHERE clauses on fields such as user_id, category, and color, executes the query against indexed columns in the database, and obtains a set of item rows. The server then converts each row into an item representation including fields required by the terminal.

### Step 14:

Server sends the search results to the terminal.

Input: The list of item representations obtained from the database.

Output: A response message containing an array of items.

Server aggregates the item representations into a collection, serializes the collection into a text-based data format, attaches it to an HTTP response, and returns it to the terminal with a success status.

### Step 15:

Terminal displays the retrieved items to the user.

Input: The serialized item list from the server.

Output: A rendered list of items on the display of the terminal.

Terminal parses the item list into an internal array, builds UI components for each item (thumbnail, category label, color label), fetches image data based on the image references, and draws the list in a scrollable view. The terminal assigns tap handlers so that the user can select items for more details or for use in coordination requests.

### Step 16:

User composes a prompt sentence to request a coordination proposal.

Input: A user text input on the terminal, optionally combined with selection of specific items.

Output: A natural language prompt sentence and a set of selected item identifiers.

User enters a sentence such as “Please suggest bottoms that match my red tops” or “Suggest three outfits using my blue jeans for a weekend outing” in a text field. The terminal records the text, tracks which items are selected in the UI, and bundles them in a coordination request object.

### Step 17:

Terminal sends a coordination request including the prompt sentence to the server.

Input: The coordination request object containing the prompt sentence, selected item identifiers, and user identifier.

Output: A network message addressed to a coordination endpoint on the server.

Terminal serializes the coordination request into a structured text format, sets appropriate HTTP headers, and transmits the request to the server via a secure network connection.

### Step 18:

Server gathers wardrobe context and user preference data.

Input: The prompt sentence, selected item identifiers, and user identifier from the coordination request.

Output: Structured wardrobe context and preference context used for AI input.

Server executes SQL queries to retrieve full attribute sets for the selected items and for other related items that match certain categories or colors. Server also queries history and feedback tables to obtain past selection events and evaluations for the user. Server then assembles these records into a set of structured, normalized entries representing the user's available wardrobe and preference tendencies.

### Step 19:

Server incorporates external contextual information such as weather and season.

Input: The user identifier, potential geographic information, and current time.

Output: Contextual features describing weather, season, and optionally emotional state.

Server requests or retrieves from a cache current and forecasted weather data for the user's location, derives season information from calendar data, and optionally obtains user emotional state estimates from an internal module. Server converts numerical and categorical values into textual or symbolic descriptors that can be included alongside wardrobe context data.

### Step 20:

Server constructs internal prompt sentences for the generative AI model.

Input: The user's past selection history, evaluation information, and extracted preference patterns.

Output: One or more internal prompt sentences describing user-specific constraints and instructions for the model.

Server analyzes preference data to detect, for example, a tendency toward certain colors or categories in specific contexts. Server then composes natural language instructions such as “The user prefers neutral colors for work days and casual sneakers for weekends” and “Avoid recommending formal jackets for running errands.” These internal prompts are added to a control segment intended only for the generative AI model.

### Step 21:

Server assembles a full model input sequence combining all segments.

Input: The wardrobe context segment, internal prompt sentences, external contextual features, and the user's prompt sentence.

Output: A composite text sequence or structured message suited for the generative AI model.

Server concatenates a system-level instruction segment, a formatted list of wardrobe items annotated with identifiers and attributes, the internal prompt sentences describing user preferences and constraints, the textual representation of weather and season, and the user's prompt sentence. Server then tokenizes this composite sequence using the generative AI model's tokenizer, resulting in a sequence of token identifiers.

### Step 22:

Server submits the tokenized input to the generative AI model and performs inference.

Input: The token sequence representing the composite input.

Output: A sequence of output tokens encoding a proposed clothing coordination.

Server sends the token sequence and inference parameters such as maximum token count and randomness settings to the generative AI model. The generative AI model processes the input with its transformer layers, iteratively computing attention-weighted representations and output logits, and returns a generated token sequence. Server decodes the returned token sequence into a human-readable text and may also detect structured patterns such as item identifiers in the output.

### Step 23:

Server parses the model output and maps proposed items to stored wardrobe items.

Input: The generated coordination text and any embedded item references.

Output: A set of specific wardrobe item identifiers and descriptions that realize the proposal.

Server applies parsing rules to the generated text to extract mentions of categories, colors, materials, and any explicit identifiers. Server then executes attribute-based queries on the items table using these extracted features to find items with high similarity. A similarity function considers multiple attributes and may weight some fields more heavily. Based on computed similarity scores, server selects one or more items for each described element in the proposal and pairs them with the descriptive text.

### Step 24:

Server enriches the coordination with purchase and location information for non-owned items.

Input: The portions of the proposal that refer to items not in the user's wardrobe.

Output: Purchase links and location descriptions associated with those items.

Server searches product and sales tables for items matching the descriptions of non-owned elements, retrieves price and vendor identifiers, and identifies layout and position information from store mapping data. Server constructs link texts and map references that specify how and where the user can obtain those items.

### Step 25:

Server composes a coordination response for the terminal.

Input: The mapped wardrobe items, enriched proposal text, purchase links, and map references.

Output: A structured response object containing coordination content.

Server organizes the coordination into one or more outfits, each including a list of item identifiers, descriptive text, and any associated purchase and location information. Server serializes this structure, attaches metadata such as confidence indicators or tags, and sends it to the terminal via a network response.

### Step 26:

Terminal presents the coordination proposal to the user.

Input: The coordination response object from the server.

Output: A visual and textual display of recommended outfits on the terminal.

Terminal parses the response, retrieves or requests images for each item identifier, and constructs a user interface showing the outfits as grouped sets of thumbnails with explanatory text. Terminal highlights which items are already in the user's wardrobe and which items are suggested for purchase, and may show a map view or link buttons for accessing purchase and location details.

### Step 27:

User reviews the coordination and optionally refines the prompt sentence.

Input: The displayed coordination results and user interactions such as edits or additional conditions.

Output: A new or modified prompt sentence and updated coordination request.

User may input additional constraints such as “Make the outfit more formal” or “Change shoes to sneakers” in a text field. Terminal records these additional instructions as a new prompt sentence or an extended prompt sentence, optionally preserves the previous context, and prepares to repeat the coordination request cycle.

### Step 28:

Terminal and server iteratively improve recommendations based on user feedback.

Input: Explicit feedback actions such as “like,” “dislike,” or “save for later,” provided by the user on individual proposals or items.

Output: Updated preference records and improved future coordination proposals.

Terminal sends feedback data to the server. Server stores this feedback in history and evaluation tables, updates aggregated preference profiles, and uses these records as part of the training or fine-tuning data for the generative AI model or an auxiliary preference model. Over time, this data-driven adjustment causes future prompt processing and inference to produce more accurate and efficient coordination proposals for the user.

### Application Example 1

Description follows regarding a flow of the specific processing in an Application Example 1. The units of the system described below are implemented by the data processing device 12 and the smart device 14. The data processing device 12 is called a “server” and the smart device 14 is called a “terminal”.

Conventional outfit recommendation systems typically perform rule-based or template-based selection of items from a user's stored wardrobe data, sometimes augmented by generic weather information. Such systems generally lack the ability to dynamically integrate multiple heterogeneous, time-varying data sources, including fine-grained weather forecasts, real-time virtual store product data, and evolving user behavioral signals. As a result, these systems often generate recommendations that are insensitive to short-term environmental changes, do not reflect items currently being browsed in online commerce environments, and fail to adapt to subtle changes in user preferences over time.

From a computer-technology standpoint, existing systems exhibit several technical limitations. First, data processing for outfit recommendation is frequently implemented as isolated, application-specific logic scattered across client and server components, leading to redundant computations, inconsistent state management, and increased resource consumption on user devices. Second, the transformation of structured context data (such as forecast parameters, wardrobe metadata, and browsing logs) into inputs for generative models is commonly performed in an ad hoc manner, without an explicit, machine-implemented pipeline that systematically encodes user history and context into machine-readable instructions. This results in suboptimal utilization of generative AI resources, unnecessary network traffic due to repeated or overspecified requests, and latency in producing recommendations.

Third, most systems do not employ a feedback loop in which selection operations and purchase operations performed at the user terminal are automatically captured, stored, and then programmatically injected into subsequent generative processing. Absent this loop, the computing system cannot effectively refine future recommendation behavior based on observed user responses, and the prompt construction logic for generative models remains static or manually tuned. This prevents the system from converging toward more accurate and computationally efficient recommendation patterns over time.

Furthermore, conventional architectures typically treat the generative AI model as a black-box text generator, without defining a structured, processor-implemented mechanism for constructing and updating prompt sentences as first-class data objects. Without such a mechanism, the system cannot reliably control which context features (such as weather-derived seasonality, trend information, product availability, and emotional state indicators) are passed into the generative processing, which in turn limits the system's ability to generate coordinated proposals that combine the user's existing belongings with real-time virtual store items under current environmental constraints.

Accordingly, there is a need for an improved computer-implemented system that: (i) centrally manages user belongings, weather data, virtual store product data, and interaction histories on a server-side processor; (ii) programmatically generates and updates prompt sentences for a generative AI model based on these heterogeneous data sources; and (iii) uses a feedback-driven mechanism to refine subsequent prompt construction and recommendation behavior. By addressing these issues, the system can improve the efficiency, adaptability, and technical quality of computer-implemented outfit recommendation processes, reduce redundant processing at user terminals, and better leverage generative AI capabilities within a controlled, server-centric architecture.

The specific processing by the specific processing unit 290 of the data processing device 12 in Application Example 1 is realized by the following means.

The present invention provides a server comprising a processor configured to store and classify information representing personal belongings possessed by a user in a storage device, to acquire weather forecast information from an external information source and analyze the weather forecast information to identify weather conditions corresponding to a predetermined time and region, to acquire merchandise information representing a product being browsed in a virtual sales environment in response to an operation performed by a user terminal and record the merchandise information in association with the user, to analyze an emotional state and preference tendencies of the user on the basis of an operation history and a response history, to generate a prompt sentence as structured input for a generative AI model on the basis of the weather forecast information, the information on the personal belongings, the merchandise information, and the preference tendencies, to input the prompt sentence to the generative AI model and cause the generative AI model to execute text generation processing so as to generate outfit proposal information combining at least one of the personal belongings and at least one product from the virtual sales environment in accordance with the identified weather conditions and the analyzed emotional state, to identify items included in the outfit proposal information and associate the items with image information and acquisition destination information, to transmit the outfit proposal information to the user terminal for display, to acquire response information representing selection operations and purchase operations from the user terminal and record the response information as history data, and to update contents of the prompt sentence on the basis of the history data so that subsequent outfit proposal information is generated in a manner reflecting the recorded user behavior. This enables a computer-implemented recommendation architecture in which server-side components efficiently orchestrate acquisition and fusion of multi-source contextual data, systematically construct and refine prompt sentences for generative AI processing, and adapt the generation of coordinated outfit proposals to real-time weather, virtual store state, and evolving user preferences, thereby improving the technical performance, responsiveness, and personalization quality of the outfit recommendation system while reducing redundant processing on user devices.

The term “system” refers to an arrangement of hardware resources and software resources including at least one server device and at least one user terminal device that cooperate via a communication network to execute the processing described in the claims.

The term “processor” refers to a hardware processing unit, such as a central processing unit or a processing core, capable of executing computer-readable instructions to perform the functions recited in the claims.

The term “user” refers to a human individual who operates a user terminal to register personal belongings, browse products in a virtual sales environment, receive outfit proposal information, and perform selection and purchase operations.

The term “personal belongings” refers to items owned or possessed by the user that can be used in an outfit, including, but not limited to, clothing items, footwear items, carrying items, and decorative items.

The term “storage device” refers to a physical or logical memory component, such as a non-volatile storage medium or a database system, that stores data including personal belongings information, weather forecast information, merchandise information, and history data.

The term “weather forecast information” refers to data representing predicted meteorological conditions for a specified region and time period, including one or more of temperature, precipitation, wind, humidity, and sky conditions.

The term “external information source” refers to a remote information-providing system, accessible over a communication network, that supplies weather forecast information or trend information to the server.

The term “weather conditions” refers to environmental parameters derived from the weather forecast information for a given time and region, such as predicted temperature range, precipitation likelihood, and general weather type.

The term “virtual sales environment” refers to an electronic commerce environment accessible via a communication network, in which products can be browsed and optionally purchased by the user.

The term “merchandise information” refers to data representing a product available in the virtual sales environment, including one or more of product category, color, brand, price, seasonality, style attributes, image information, and acquisition destination information such as a purchase link.

The term “user terminal” refers to an electronic device operated by the user, such as a mobile terminal or a computing device, that is capable of communicating with the server, displaying information, and sending user operations to the server.

The term “operation history” refers to data representing operations performed by the user through the user terminal, including one or more of browsing actions, selection actions, and input actions.

The term “response history” refers to data representing responses by the user to previously provided outfit proposal information, including acceptance, rejection, modification, and purchase decisions.

The term “emotional state” refers to an estimated psychological condition of the user, inferred from one or more of interaction patterns, explicit feedback, or other sensor-based input, and represented as data that may influence outfit proposals.

The term “preference tendencies” refers to patterns of user preference inferred from the operation history and the response history, including favored outfit styles, preferred color combinations, and frequently selected categories of personal belongings and merchandise.

The term “generative AI model” refers to a machine-learned model capable of generating text output based on input data, where the model is implemented by a neural network or other machine learning architecture and performs text generation processing in response to a prompt sentence.

The term “prompt sentence” refers to a machine-generated or machine-constructed textual instruction or input sequence provided to the generative AI model, the prompt sentence including contextual information such as weather forecast information, personal belongings information, merchandise information, and preference tendencies.

The term “text generation processing” refers to computational operations performed by the generative AI model to generate textual output in response to a prompt sentence, including generating descriptions, explanations, or structured text representing outfit proposals.

The term “outfit proposal information” refers to information generated through text generation processing by the generative AI model that specifies one or more combinations of personal belongings and merchandise items to form an outfit, optionally including explanatory text, style descriptors, and reasoning.

The term “image information” refers to data indicating visual representations of personal belongings or merchandise items, such as image file identifiers, image file locations, or direct image data usable for display at the user terminal.

The term “acquisition destination information” refers to data identifying a source or method by which a merchandise item can be obtained, including a network resource identifier or link for purchasing the item in the virtual sales environment.

The term “selection operations” refers to user actions at the user terminal that indicate choosing or favoring particular outfit proposals or items, such as selecting a recommended outfit or adding an item to a list.

The term “purchase operations” refers to user actions at the user terminal that initiate or complete acquisition of merchandise items in the virtual sales environment, such as executing a purchase command or confirming a transaction.

The term “response information” refers to data transmitted from the user terminal to the server indicating results of the selection operations and purchase operations, including whether an outfit proposal or item was selected, ignored, or purchased.

The term “history data” refers to accumulated records of response information and other related user interaction data that are stored over time and used to update prompt sentences and preference tendencies.

The term “preference information” refers to summarized data describing an outfit style preferred by the user, favorable color combinations, and preferred types of personal belongings, derived from the preference tendencies and the history data and included in the prompt sentence.

The term “seasonality information” refers to data representing seasonal characteristics relevant to outfit generation, derived from one or more of the weather forecast information and calendar information, and indicating, for example, season-dependent suitability of items.

The term “calendar information” refers to data representing dates or periods in a calendar, including information such as month, season, holidays, or events that may influence outfit selection.

The term “trend information source” refers to an external information-providing system that supplies information on current fashion trends or style tendencies.

The term “trend information” refers to data representing style trends or fashion tendencies obtained from the trend information source and usable for adjusting outfit proposals.

The term “purchase information” refers to information derived from the merchandise information that supports purchasing behavior, including availability, pricing, and purchasing links for items in the virtual sales environment.

The term “guidance information” refers to information indicating a position or location of a product within the virtual sales environment, or navigation-related data that assists the user in accessing the product.

Various embodiments for carrying out the invention will now be described. In the following description, the term “server” denotes one or more computing devices including at least one processor and at least one storage device, the term “terminal” denotes a user-operated computing device, and the term “user” denotes a human operator of the terminal.

### 1. Overall System Configuration

The server executes a program stored in a non-transitory computer-readable storage medium. The server includes at least one processor such as a central processing unit, at least one main memory such as a random access memory, at least one storage device such as a magnetic disk or solid state drive, and at least one network interface. The server is connected, via a communication network, to an external information source that provides weather forecast information and trend information, and to one or more terminals.

The terminal includes a processor, a memory, a display device, an input device such as a touch panel, and a communication interface. The terminal executes an application program that communicates with the server using a network protocol such as HTTP over a secure channel.

The server operates on a computing platform such as a virtual machine or container instance, and may employ a server operating system such as a general-purpose server operating system. The server accesses a database system such as a relational database management system to store and retrieve information relating to personal belongings, weather forecasts, merchandise, and history data. In one embodiment, the server uses a data access library (for example, an object-relational mapping framework) to map application data structures to database tables.

The server communicates with a generative AI model that is deployed on a computing system including one or more graphics processing units or specialized accelerators. The generative AI model is implemented as a neural network having a transformer architecture with multiple attention layers, feed-forward layers, and normalization layers, trained on large-scale text data to perform sequence-to-sequence text generation. The server accesses the generative AI model through an application programming interface, hereinafter referred to as a model API.

### 2. Data Structures and Storage

The server uses structured data models for each type of information.

The server stores personal belongings in a belongings table. Each record includes at least: a user identifier, a belonging identifier, a category field representing a generalized item type (such as upper-body garment, lower-body garment, footwear, carrying article, decorative article), a color field storing a standardized color label or color code, a material field, a seasonality field indicating the seasons for which the item is suitable, a style tag field storing a list or set of style attributes (such as casual, formal, outdoor), and an image reference field storing a reference to image information.

The server stores weather forecast information in a forecast table. Each record includes at least: a region identifier, a time interval, a temperature value or range, a precipitation probability, a weather type code, and optionally wind speed and humidity. The server normalizes units and stores numeric values to enable efficient computation of thresholds and comparisons.

The server stores merchandise information in a merchandise table. Each record includes at least: a merchandise identifier, a category, a color, a style descriptor, a seasonality descriptor, a price range, an availability status, an image reference, and acquisition destination information such as a network resource identifier.

The server stores history data in a history table. Each record includes at least: a user identifier, an outfit proposal identifier, time of presentation, user selection information, purchase information, and labels summarizing whether the user accepted or rejected certain combinations. The server also stores statistical preference data in a preference table that holds, for each user, aggregated scores over categories, colors, styles, and item types.

This explicit structuring enables the server to perform indexed queries and joins that reduce the computation time for context aggregation and reduce the amount of redundant data retrieved and transmitted to the generative AI model, thus improving overall processing efficiency.

### 3. Server-Side Processing Modules

The server executes several logical modules implemented as software components running on the processor.

The server includes a belongings management module that receives belongings registration requests from the terminal, validates the input, stores belongings data in the belongings table, and associates images with stored records. The server may use an image analysis sub-module based on a convolutional neural network to infer a representative color or pattern from the image, and stores such inferred attributes as additional fields. This automated feature extraction reduces manual input and ensures consistent item descriptors, which in turn improves the reliability of subsequent recommendation computations.

The server includes a weather acquisition module that periodically calls an external forecast service through the network interface. The server converts a requested date, time, and user region into parameters for an application programming interface of the external information source. The server parses the returned structured data and transforms raw forecast values into normalized weather conditions stored in the forecast table. The server computes derived fields such as a comfort index or rainfall risk score by applying deterministic functions to the numeric parameters.

The server includes a virtual sales environment interaction module that obtains merchandise identifiers and browsing events from the terminal. The server looks up, in the merchandise table or an external merchandise source, detailed attributes of products being browsed, and stores them in association with user identifiers in a browsing context table. The server may also compute similarity scores between browsed products and existing belongings using feature vectors representing color, style, and seasonality, in order to restrict the candidate set of merchandise considered in outfit generation. Such similarity computation can employ vector operations executed by the processor, reducing the search space and improving computational efficiency for later steps.

The server includes an emotion and preference analysis module that transforms operation history and response history into numeric feature vectors. In one embodiment, the server assigns numeric codes to actions such as “view outfit”, “accept outfit”, “ignore outfit”, and “purchase merchandise”, and uses time-series aggregation to derive feature counts over a sliding window. The server applies, for example, logistic regression or a small feed-forward neural network to estimate a discrete emotional state (such as positive, neutral, or negative) and to update preference scores in the preference table. The module uses a loss function, such as cross-entropy, during training to align predicted acceptance probabilities with actual user behavior, and updates model weights using a gradient-based optimization algorithm. This structured analysis enables the server to adapt the recommendation logic to the user's evolving behavior in a way that cannot be performed reliably by simple rules.

The server includes a prompt construction module that converts the heterogeneous data weather conditions, belongings, merchandise, emotional state, and preference tendencies-into a structured prompt sentence. The module applies deterministic rules for ordering and formatting information. For example, the module first inserts a role instruction to the generative AI model, then appends a structured listing of belongings, then appends currently browsed merchandise, then appends summary sentences representing weather and emotional state, and finally appends explicit output constraints (such as the number of outfits and the explanation style). By formalizing prompt construction as a programmable transformation, the server achieves consistent model inputs with reduced variability, which leads to more stable model outputs and a reduction in failed or unusable responses.

The server includes a generative inference interface module that submits the prompt sentence to the generative AI model and receives generated text. The module controls parameters such as sampling temperature and maximum output length, and chooses them based on context, for instance, lowering variability for users who have shown strong, narrow preferences. The module may implement backoff logic that reduces the size of the prompt or changes parameters if previous requests encountered timeout or resource limitations.

The server includes an output post-processing module that parses the generated text to extract references to belongings and merchandise. The module uses pattern matching and, optionally, semantic similarity matching to map natural language item descriptions to stored item identifiers. For example, the module computes cosine similarity between a vector representation of a generated item description and vector representations of stored item metadata to resolve ambiguous references. The mapping is stored alongside the text output as part of the outfit proposal information. The module discards or corrects proposals that cannot be mapped to existing items, thereby ensuring that all presented combinations are actionable and can be visually displayed and optionally purchased.

The server includes a feedback logging module that receives response information from the terminal and writes structured records into the history table. The module then updates aggregate counts and preference scores in the preference table. The server uses these updated scores when constructing subsequent prompt sentences, explicitly inserting phrases such as “the user prefers dark neutral colors and casual footwear” into the prompt. This closed loop between output, user reaction, and prompt update causes the system to converge toward proposals with higher acceptance probability.

### 4. Generative AI Model Structure and Learning

The generative AI model used in the system may be a transformer-based language model that includes an embedding layer, a plurality of attention blocks, and an output projection layer. The model parameters include word embeddings, positional encodings, attention weights, and feed-forward weights. The model is trained using text corpora that include description and recommendation patterns.

In one embodiment, the server performs additional fine-tuning of the generative AI model on domain-specific data. The server constructs training examples consisting of input prompt sentences and target output texts representing high-quality outfit proposals. The server defines a loss function such as token-level cross-entropy between the generated sequence and the target sequence. During training, the model weights are updated by a stochastic gradient descent-based algorithm. The server may apply data augmentation techniques such as paraphrasing or substitution of item attributes to diversify training samples. As a result, the model learns to interpret structured prompt sentences containing belongings, merchandise, and weather attributes, and to produce outputs that respect constraints embedded in the prompt.

In addition, the server can implement a reinforcement learning loop in which rewards are derived from history data (for example, assigning higher reward to proposals that led to purchases). In such an embodiment, the server uses user feedback as reward signals to adjust a policy over model parameters or decoding strategies. This leads to a reduction in generation of low-relevance proposals and improves computational efficiency by reducing the number of iterations needed to obtain acceptable outputs.

By providing explicit, machine-constructed prompt sentences with context summaries, style preferences, and constraints, the server guides the generative AI model in a way that is structurally different from unstructured human prompts and from mere automation of human text entry. The system thereby improves the accuracy and reliability of generative output when applied to outfit proposals and reduces the need for repeated trial interactions.

### 5. Example of Prompt Sentence

The server constructs a prompt sentence as follows, using information from the belongings table, the forecast table, the merchandise table, and the preference table:

“You are a fashion stylist AI.

Use the user's personal belongings and the currently viewed product from the virtual sales environment to generate personalized outfit suggestions.

User's personal belongings:
Upper-body garment: blue knit sweater (casual, suitable for cool seasons)
Lower-body garment: black jeans (casual, all-season)
Footwear: white sneakers (casual, not waterproof)
Carrying article: black leather bag (business casual)

Currently viewed product in the virtual sales environment:
Outerwear: red jacket (water-resistant, casual, suitable for cool seasons)

Weather forecast:
Location: metropolitan area
Time: today during the day
Condition: cloudy with occasional rain, temperature 12° C. (cool and humid)

User preference summary:
The user prefers casual and simple outfits.
The user frequently selects dark neutral colors and sneakers.

Generate 1-3 outfit suggestions in English that are suitable for this weather and preference profile.

Each suggestion must specify which personal belongings and which store products to use, and briefly explain why the combination works in terms of color, style, and weather suitability.”

The server sends this prompt sentence to the generative AI model. The model outputs text describing one or more outfits. The server then maps referenced items to stored identifiers and attaches corresponding image information and acquisition destination information.

### 6. Terminal-Side Behavior

The terminal executes an application program that interacts with the server. The terminal transmits belongings registration information, browsing events, and response information, and displays outfit proposal information received from the server.

The terminal renders images of personal belongings and merchandise by retrieving bitmap data based on image references sent by the server. The terminal displays textual descriptions directly as generated by the generative AI model. Because the server already resolves item identifiers and links, the terminal's processing remains relatively simple and does not need to implement complex matching logic. This division of labor reduces computational burden on the terminal processor and reduces energy consumption on mobile devices, which is a technical advantage particularly for battery-powered terminals.

### 7. Technical Effects and Computer-Technology Improvement

The described system achieves multiple technical effects that go beyond a mere automation of human recommendation work.

The server centralizes all heavy computation, including data aggregation, feature extraction, and generative inference orchestration. By representing belongings, weather, and merchandise information in structured database tables with normalized fields, the server can perform efficient queries and aggregations, leading to lower latency in preparing context.

This data management approach reduces redundant storage and allows indexed retrieval, which directly improves processing speed.

The server constructs prompt sentences using deterministic rules that encode user behavior statistics, weather conditions, and browsing context into a compact, machine-readable string.

This compact representation reduces the size of input transmitted to the generative AI model compared to sending raw logs or unprocessed metadata. The reduction in prompt length leads to reduced computational complexity for the model, lower inference time, and decreased network traffic between the server and the model host.

The feedback-driven update of prompt contents based on history data causes the system to adapt: the server gradually shifts emphasis towards items and styles likely to be accepted, which results in fewer rejected proposals and reduces the number of iterations needed to reach a satisfactory outcome. This leads to fewer calls to the generative AI model for a given decision, thereby saving processing resources.

The use of numerical features and trained models in the emotion and preference analysis module allows the server to derive latent patterns that are not easily captured by human-defined rules. Because the server uses supervised learning methods, loss functions, and weight updates, it can automatically tune parameters to minimize prediction error for future user responses. This causes the entire pipeline-from context aggregation to prompt construction-to become more accurate as data accumulates.

The described architecture focuses on the internal operation of the computing system: data structures, feature extraction, neural network training, and controlled interaction with the generative AI model. By specifying the model architecture (transformer), training procedures (loss functions, gradient updates), and prompt construction algorithm, the system presents a concrete improvement to how computers generate and refine complex, context-dependent textual outputs for outfit coordination, rather than simply implementing a business process.

The combination of structured data storage, optimized prompt design, and feedback-aware inference control yields measurable improvements in computation time, bandwidth usage, and output accuracy.

### 8. Variations and Alternative Embodiments

The server may employ alternative model architectures for the generative AI model, such as recurrent neural networks augmented with attention mechanisms, or mixed encoder-decoder architectures, provided that the model accepts text-based prompt sentences and outputs text-based proposals. The emotion and preference analysis module may use different machine learning algorithms, such as gradient boosting or support vector machines, to estimate user emotional state and preferences. The system may also integrate an additional ranking module that uses a separate scoring model to reorder generated proposals according to predicted user acceptance.

The server may choose to pre-compute, at scheduled times, prompt segments for likely user contexts (for example, morning commute or evening events), cache them, and reuse them with minimal modifications. This pre-computation reduces real-time computation load and improves response time.

The terminal may be implemented as a native application, a web-based application, or a hybrid application. The communication protocol between the server and the terminal may use different serialization formats, as long as the logical structure of the messages respects the delineation between belongings information, merchandise information, and outfit proposal information.

In all such variations, the core concept remains that the server manages structured context data, constructs and updates prompt sentences as first-class data objects for a generative AI model, and refines the generation process through explicit feedback from user interactions, thereby improving the technical performance of the computer-based outfit recommendation system.

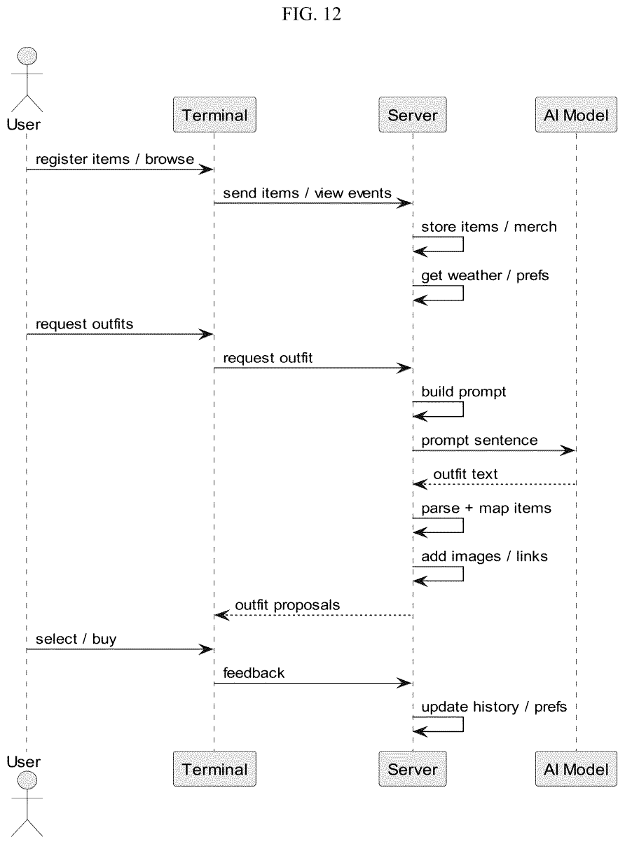

The following describes the processing flow using FIG. 12.

### Step 1:

The user operates the terminal to register personal belongings.

The user selects or captures images of items and inputs attributes such as category, color, material, and style tags into an application screen.

Input: raw image data and textual attribute entries provided by the user.

The terminal converts the images into compressed image files and structures the attribute entries into a data object.

Output: a formatted registration request containing the compressed image and structured attribute data.

### Step 2:

The terminal transmits the belongings registration request to the server.

The terminal opens a secure network connection, serializes the data object into a request message, and sends the message to a designated server endpoint.

Input: the formatted registration request from Step 1.

The terminal encapsulates the data in a communication protocol frame and includes a user identifier and timestamp.

Output: a network message delivered to the server containing belongings registration data.

### Step 3:

The server receives and validates belongings information.

The server parses the incoming message, checks data types and required fields, and verifies that image size and attribute values fall within allowed ranges.

Input: the network message from the terminal containing image data and attribute data.

The server performs data validation and consistency checks (for example, verifying that the category is one of predefined generalized categories).

Output: a normalized belongings record object suitable for storage, or an error response if validation fails.

### Step 4:

The server stores belongings information in structured storage.

The server maps the normalized belongings record object to one or more rows in a belongings table and stores image references in a storage index.

Input: the validated belongings record object from Step 3.

The server assigns a unique belonging identifier, converts attribute values to normalized internal codes if needed, and writes the data to the database.

Output: a stored belongings entry associated with the user and a confirmation response sent to the terminal.

### Step 5:

The server acquires weather forecast information for the user.

The server generates a request with region and time parameters and sends it to an external information source.

Input: a region identifier and a time interval associated with the user.

The server receives raw forecast data, parses it, converts units if necessary, and extracts fields such as predicted temperature, precipitation probability, and weather type codes.

Output: a weather condition record stored in a forecast table and available for later retrieval.

### Step 6:

The user operates the terminal to browse products in a virtual sales environment.

The user navigates through product lists, selects a product detail view, and scrolls or interacts with the display.

Input: user interface actions such as taps or clicks.

The terminal interprets these actions and identifies the currently displayed product identifier and relevant page metadata.

Output: a browsing event object representing the user's current product view.

### Step 7:

The terminal sends browsing event information to the server.

The terminal packages the product identifier, user identifier, and timestamp into a request and transmits it to the server.

Input: the browsing event object from Step 6.

The terminal serializes the event into a machine-readable format and sends it via a network connection.

Output: a browsing event message delivered to the server that indicates which product is being viewed.

### Step 8:

The server retrieves and stores merchandise information associated with the browsing event.

The server uses the product identifier to query internal merchandise storage or an external merchandise source for detailed attributes such as category, color, style, seasonality, and acquisition destination.

Input: the browsing event message containing the product identifier.

The server joins or merges the retrieved attributes into a merchandise record and records this merchandise record in association with the user in a browsing context table.

Output: a stored merchandise context entry that links the user to currently viewed products.

### Step 9:

The server aggregates operation history and response history to estimate preference tendencies and emotional state.

The server queries history tables to retrieve past selection operations, purchase operations, and acceptance or rejection of outfit proposals.

Input: historical interaction data, including time-stamped actions and associated proposal identifiers.

The server computes feature vectors by counting frequencies of actions per category, color, and style, and applies a trained model, such as a small neural network or logistic regression, to classify emotional state and update preference scores.

Output: updated preference tendency records and an estimated emotional state value for the user.

### Step 10:

The server prepares context data for prompt construction.

The server retrieves, from storage, a set of belongings for the user, recent weather conditions, current merchandise context, and updated preference tendencies.

Input: belongings table entries, forecast table entries, merchandise context entries, and preference table entries.

The server filters belongings by seasonality and relevance, selects current weather records for the target time and region, and composes summary descriptors such as “cool and rainy” or “prefers casual dark outfits” based on numeric parameters.

Output: a structured context bundle containing selected belongings, weather summary, merchandise summary, and preference summary.

### Step 11:

The server generates a prompt sentence for a generative AI model.

The server orders the context bundle into sections and formats them into a single textual prompt.

Input: the structured context bundle from Step 10.

The server concatenates a role instruction, a list of belongings descriptions, a description of currently viewed merchandise, a weather description, and a preference summary, and then appends explicit output requirements such as number of suggestions and explanation style.

Output: a prompt sentence that encodes all necessary context for the generative AI model.

### Step 12:

The server sends the prompt sentence to the generative AI model and obtains generated text.

The server transmits the prompt sentence to a model API, specifying model parameters such as sampling temperature and maximum output length.

Input: the prompt sentence from Step 11 and model configuration parameters.

The generative AI model processes the sequence and returns a text output consisting of one or more outfit proposals.

Output: a generated text response containing natural-language descriptions of outfit proposals.

### Step 13:

The server parses the generated text into structured outfit proposal information.

The server scans the text for item descriptions, identifies which parts correspond to belongings and which to merchandise, and segments the text into individual proposal units.

Input: the generated text response from Step 12.

The server uses pattern matching rules, and optionally semantic similarity measures, to map textual item references to belonging identifiers and merchandise identifiers stored in the database.

Output: a set of structured outfit proposal records, each including selected belongings, selected merchandise, and explanatory text.

### Step 14:

The server enriches the outfit proposals with image information and acquisition destination information.

The server looks up image references for belongings and merchandise, and retrieves or generates links for acquiring merchandise in the virtual sales environment.

Input: the structured outfit proposal records from Step 13.

The server associates each item with corresponding image URLs or identifiers and with acquisition destination information such as purchase links.

Output: complete outfit proposal information objects containing item identifiers, image references, acquisition links, and explanatory text.

### Step 15:

The server transmits outfit proposal information to the terminal.

The server packages the proposal information objects into a response message and sends the message to the terminal over the network.

Input: the enriched outfit proposal information objects from Step 14.

The server serializes the data into a format suitable for the terminal and includes metadata such as proposal identifiers and timestamps.

Output: a response message delivered to the terminal containing one or more outfit proposals.

### Step 16:

The terminal receives and displays outfit proposal information.

The terminal parses the response message and constructs display elements such as images, text blocks, and interaction buttons.

Input: the outfit proposal response message from Step 15.

The terminal retrieves or decodes the image data based on the provided references and arranges items visually on the display, attaching text explanations and purchase or selection controls.

Output: a rendered user interface presenting complete outfit proposals to the user.

### Step 17:

The user reviews, selects, or purchases from the displayed outfit proposals.

The user reads the explanations, inspects item images, and performs actions such as selecting a recommended outfit or initiating a purchase.

Input: the visual presentation and interaction controls rendered on the terminal.

The user performs touch or click operations corresponding to acceptance, rejection, or purchase of merchandise items.

Output: user interaction events that represent selection operations and purchase operations.

### Step 18:

The terminal transmits response information about user actions to the server.

The terminal constructs response data objects encoding which proposal was selected, which items were purchased, or which proposals were ignored, and sends them over the network.

Input: the user interaction events captured in Step 17.

The terminal adds identifiers for the user, the proposal, and the affected items, and timestamps the events before transmission.

Output: response information messages received by the server indicating user feedback.

### Step 19:

The server logs response information and updates history and preferences.

The server writes response entries into the history table and updates aggregate statistics in the preference table.

Input: response information messages from Step 18.

The server increments counters for accepted and rejected combinations, recalculates preference scores for categories, colors, and styles, and may recompute emotional state estimates based on aggregated outcomes.

Output: updated history data and updated preference tendency data stored for future processing.

### Step 20:

The server refines future prompt sentences based on the updated history and preferences.

The server adjusts the weighting of preference descriptors and selection of belongings and merchandise when constructing subsequent context bundles and prompt sentences.

Input: the updated preference tendency data and history data from Step 19.

The server modifies rules or parameters used by the prompt construction module, for example, emphasizing items and styles with higher acceptance scores and de-emphasizing those frequently rejected.

Output: an updated prompt construction configuration that will guide generation of more personalized and efficient prompt sentences for later invocations of the generative AI model.

It is also possible to incorporate an emotion engine for estimating the user's emotions. That is, the specific processing unit 290 may estimate the user's emotions using an emotion identification model 59, and perform specific processing based on the estimated emotions.

### Example 2

Description follows regarding a flow of the specific processing in an Example 2. The units of the system described below are implemented by the data processing device 12 and the smart device 14. The data processing device 12 is called a “server” and the smart device 14 is called a “terminal”.

Conventional outfit recommendation systems that operate on information processing apparatuses typically rely on static rule sets, manually curated style databases, or simple filtering based on weather conditions and user-registered items. In such systems, a processor generally performs limited matching between stored garment information and coarse weather categories, and then outputs a fixed set of suggestions. As a result, these systems exhibit several technical drawbacks from a computer technology perspective.

First, conventional systems do not dynamically generate machine-readable instruction content (prompt sentences) that fully utilize heterogeneous context data such as detailed meteorological information, user preference histories, temporal information, and trend information. Instead, they apply rigid selection logic embedded directly in application code.

This architecture constrains the expressive bandwidth of the interaction between the local processor and an external generative AI model, leading to suboptimal utilization of computational resources on both sides and limiting the adaptability of the system. Second, existing architectures typically treat outputs from external AI services as opaque natural language text without structured post-processing. The processor often forwards the raw text to a user interface, which forces the terminal-side software or the user to interpret and decompose the proposal. This leads to inefficient use of memory structures and data models within the system, because the proposed outfits are not converted into normalized component information (for example, structured fields for upper-body items, lower-body items, footwear, and accessories). As a result, the system cannot easily reuse proposal results for subsequent computation, logging, or feedback learning, and the internal data flow remains weakly structured and difficult to optimize.

Third, conventional systems do not tightly integrate feedback loops between the user's evaluations and the generation of subsequent proposals. While some systems may log simple “like/dislike” information, they do not systematically encode such preference and evaluation information into the prompt sentences that control the behavior of a remote generative AI model. Consequently, the processor fails to adapt the instruction content in a way that incrementally improves personalization quality over time, and the overall computing pipeline does not evolve into a more efficient, user-specific decision support mechanism.

Fourth, prior systems generally handle contextual factors such as seasonality, temporal conditions, and prevailing fashion trends through pre-coded rules or static category labels. They do not integrate these factors into unified, dynamically constructed prompt sentences that are explicitly designed to cause an external generative AI model to compute season-aware, trend-aware proposals and to output additional purchase candidate information and sales-location guidance. This separation of concern results in redundant computations across multiple subsystems, increases system complexity, and hampers scalability and maintainability when updating rules or incorporating new context sources.

Therefore, there is a need for an improved computer-implemented system and method in which a processor: (i) manages garment article information and meteorological information in a structured manner; (ii) generates context-rich prompt sentences for a generative AI model based on multiple types of stored information; (iii) post-processes the AI model's output into structured component information; and (iv) uses this information to provide machine-readable proposed outfit information to terminal devices. Such a system should improve internal data flow, enable more precise personalization through iterative feedback incorporation, and enhance the efficiency and technical capabilities of the overall computing environment that supports outfit recommendation.

The specific processing by the specific processing unit 290 of the data processing device 12 in Example 2 is realized by the following means.

The present invention provides a server comprising a processor and a memory storing instructions that, when executed by the processor, cause the processor to store and manage garment article information registered by a user as storage information, to acquire user location information and, based on the user location information, to acquire meteorological information from an external information provision apparatus and store the meteorological information as storage information, to generate a prompt sentence for input to a generative AI model on the basis of at least the garment article information and the meteorological information and to transmit the prompt sentence to the generative AI model, to receive outfit proposal information output from the generative AI model in response to the prompt sentence and to analyze the outfit proposal information to convert the outfit proposal information into structured component information, to generate proposed outfit information including at least upper-body article information, lower-body article information, footwear article information, and accessory article information on the basis of the component information and to transmit the proposed outfit information to a terminal device, and to generate control information that enables the proposed outfit information to be presented as display information on the terminal device, and optionally further cause the processor to acquire user preference information, evaluation information, time information, calendar information, trend information, and purchase-related information from the storage information and incorporate instruction content reflecting such information into the prompt sentence so that the generative AI model performs personalized, season-aware, and trend-aware outfit proposals and generates purchase candidate information and sales-location guidance information. This enables a computing architecture in which the server-side processor systematically constructs and updates context-rich machine-readable prompt sentences, efficiently leverages a generative AI model as a remote computational resource, converts returned natural language proposals into normalized data structures, and delivers structured outfit information and associated guidance to terminal devices, thereby improving internal data management, personalization performance, and the overall technical operation of the outfit recommendation system.

The term “processor” refers to a hardware information processing unit, such as a central processing unit or other computational circuitry, that executes instructions to perform data acquisition, data storage, data analysis, and control operations in the system.

The term “memory” refers to a hardware storage resource, such as volatile memory or non-volatile memory, that stores instructions and data to be read and written by the processor.

The term “storage information” refers to data that is stored in the memory in an organized format, including but not limited to user-related data, environmental data, historical data, and control data used by the processor.

The term “garment article information” refers to information representing wearable items owned or used by a user, including at least category, type, or attribute data for upper-body articles, lower-body articles, footwear, and accessories.

The term “user location information” refers to information indicating a geographical position associated with a user, such as coordinates, region identifiers, or other position-related data usable for external data retrieval.

The term “external information provision apparatus” refers to a remote information processing system or service that provides environmental data, such as meteorological data, in response to a request including user location information.

The term “meteorological information” refers to data indicating atmospheric or weather-related conditions for a given location and time, including at least temperature, precipitation, wind, or descriptive weather status.

The term “prompt sentence” refers to a machine-readable text instruction or instruction set constructed by the processor and intended to be supplied as input to a generative AI model in order to control or guide generation processing.

The term “generative AI model” refers to an automated information processing model that generates output information, such as natural language text, on the basis of input data including prompt sentences and context information.

The term “outfit proposal information” refers to output information produced by the generative AI model in response to a prompt sentence and representing one or more proposed combinations of garment articles.

The term “component information” refers to structured data derived from outfit proposal information, specifying individual elements within a proposed outfit, such as item categories, attributes, or identifiers.

The term “proposed outfit information” refers to structured data generated by the processor on the basis of component information and including explicit fields for upper-body articles, lower-body articles, footwear, accessories, and related explanatory content.

The term “upper-body article information” refers to component information corresponding to items worn on the upper portion of a user's body, such as shirts, blouses, jackets, or similar categories.

The term “lower-body article information” refers to component information corresponding to items worn on the lower portion of a user's body, such as pants, skirts, or similar categories.

The term “footwear article information” refers to component information corresponding to items worn on a user's feet, such as shoes, boots, or similar categories.

The term “accessory article information” refers to component information corresponding to supplemental wearable items, such as bags, jewelry, belts, scarves, or similar categories.

The term “terminal device” refers to a user-operated electronic device, such as a mobile device, computing device, or display apparatus, that communicates with the server and presents proposed outfit information to the user.

The term “control information” refers to data generated by the processor that defines or influences how proposed outfit information is formatted, transmitted, or rendered as display information on a terminal device.

The term “display information” refers to information that is configured for presentation on a visual output device, such as a screen, including textual or graphical representations of proposed outfit information.

The term “user preference information” refers to data indicating tendencies, likes, dislikes, or style preferences of a user, derived from explicit input or inferred from user behavior and stored in the memory.

The term “evaluation information” refers to data representing user feedback or assessments of past outfit proposals, including ratings, selection history, or other response indicators.

The term “time information” refers to data indicating temporal context, such as time of day, date, or time period, used to influence outfit proposals.

The term “calendar information” refers to data indicating calendar-based context, such as day of the week, holidays, seasons, or scheduled events, used in generating outfit proposals.

The term “trend information” refers to data indicating prevailing or current style tendencies, fashion patterns, or popularity metrics related to garment articles or outfit combinations.

The term “purchase-related information” refers to data indicating availability, price, or acquisition options for garment articles, including information usable to generate purchase candidates and sales-location guidance.

The term “purchase candidate information” refers to information representing one or more garment articles recommended for acquisition by a user, based on deficiencies or preferences identified relative to existing garment article information.

The term “sales-location guidance information” refers to information indicating where recommended garment articles can be obtained, such as store identifiers, locations, or access guidance.

The term “personalized proposals” refers to outfit proposals generated by the generative AI model that are configured to reflect user preference information and evaluation information specific to an individual user.

The term “season-aware proposals” refers to outfit proposals that are configured to take into account meteorological information, calendar information, and seasonal characteristics for improved contextual suitability.

In one embodiment, a server, a terminal, and a user cooperate to implement the claimed system. The server includes at least one processor, a main memory, a non-volatile storage device, and a network interface. The terminal includes at least one processor, a memory, a display, an input interface, and a network interface. The user operates the terminal to register garment article information and to utilize outfit proposals generated by the system.

The server runs an operating system such as a Unix-like system and executes server-side software implemented, for example, using a web application framework such as a scripting-language-based framework or a virtual-machine-based framework. The server also executes database management software such as a relational database management system to store garment article information, meteorological information, user preference information, evaluation information, and other context data. The server further executes a client library for communication with an external generative AI model via a network-based application programming interface.

The terminal runs a mobile operating system or a desktop operating system and executes an application (native or web-based) that provides user interface screens for item registration, preference input, and display of proposed outfits. The terminal uses its network interface (wireless or wired) to communicate with the server over secure communication channels, for example using Hypertext Transfer Protocol Secure.

The user operates the terminal to register garment article information. The terminal presents input user interface elements that allow the user to specify, for each garment article, at least a category (for example, upper-body article, lower-body article, footwear, or accessory), basic attributes (such as color, material type, thickness, or seasonality), and optional additional descriptors (such as formality level or style tags). The terminal stores the user input briefly in local memory and then transmits the garment article information to the server as structured data. The server receives the garment article information, validates the data structure, and stores it in tables of the relational database as storage information. The server uses field structures such as user identifiers, item identifiers, category fields, attribute fields, and timestamps, enabling efficient indexing and retrieval.

The server acquires meteorological information from an external information provision apparatus. The terminal obtains user location information using location services available in the operating system, and transmits this user location information to the server. The server uses the network interface to send a request to an external meteorological data service, providing the user location information as query parameters. The external information provision apparatus returns meteorological information including numerical and categorical values such as temperature, humidity, precipitation forecasts, wind speed, and textual weather descriptions. The server parses the response into typed fields and stores the meteorological information in the database as storage information associated with the corresponding user and a time index. By using a normalized database schema for meteorological records, the server can efficiently query and join meteorological information with garment article information and other context data.

The server generates a prompt sentence as a machine-readable instruction string for a generative AI model. The server retrieves from the database, for a given user, the relevant garment article information, the latest meteorological information, and optionally user preference information, evaluation information regarding past proposals, time information, calendar information, trend information, and purchase-related information. The server assembles these data into an internal structured object, for example a hierarchical key-value structure, which is then converted into a natural-language prompt sentence according to a predefined template.

In one example, the server constructs a prompt sentence of the following form: “You are a fashion coordinator. Use only the user's items listed below and consider the weather and situation.

User's items: blue shirt (top), black pants (bottom), white sneakers (shoes), gray cardigan (outerwear).

Weather: clear sky, temperature 25° C., light wind, no rain expected.

Situation: casual office during the day.

Constraints: use only the listed items; choose one top, one bottom, one pair of shoes, and optionally outerwear.

Propose one recommended outfit and briefly explain why it suits the weather and situation.” In another example, the server constructs a prompt sentence reflecting adverse weather: “You are a fashion coordinator. Use only the user's items listed below and consider the cold, rainy weather and commuting conditions.

User's items: hooded waterproof jacket, black jeans, water-resistant boots, compact folding umbrella.

Weather: heavy rain, temperature 8° C., strong wind.

Situation: commuting to an office and walking outdoors for approximately 20 minutes.

Constraints: maximize protection from rain and wind while maintaining comfort. Propose one recommended outfit using only the listed items, and explain why it is appropriate.”

In yet another example, the server constructs a prompt sentence including user preferences and trend information:

“You are a fashion coordinator. The user prefers casual styles and frequently chooses sneakers. Avoid very formal combinations.

User's items: white T-shirt, striped long-sleeve shirt, beige chinos, navy shorts, brown loafers, white sneakers, light denim jacket.

Weather: hot and humid, temperature 30° C., possibility of light rain in the evening.

Situation: casual dinner at a restaurant.

Trends: light-colored tops and relaxed-fit bottoms are currently popular.

Constraints: use only the listed items; recommend one outfit and justify the choice, considering user preferences, weather, and current trends.”

The server uses these template-based assembly rules to generate prompt sentences that encode multiple types of context data in a single text stream. This structured construction of the prompt sentence differs from simple concatenation of user and weather information; the server applies non-trivial selection logic, such as filtering out items inappropriate for the current season, adjusting descriptive phrases for extreme weather, and ordering item lists according to category to reduce ambiguity for the generative AI model. As a result, the prompt sentence achieves higher information density and reduces the need for repeated clarification queries, thereby increasing communication efficiency and lowering network and computation load.

The server transmits the prompt sentence to the generative AI model. In one embodiment, the server calls an external generative AI model that is implemented as a large-scale neural network, such as a multi-layer transformer-based sequence model. This generative AI model consists of multiple encoder-decoder or decoder-only blocks, each block including self-attention layers, feed-forward layers, layer normalization circuits, and learned parameter matrices. The model has parameters such as the number of layers, attention heads, hidden unit dimensions, and vocabulary size, and has been trained using gradient-based optimization methods such as stochastic gradient descent with variants like adaptive moment estimation. During training, the generative AI model has been adjusted to minimize an objective function such as cross-entropy loss between predicted token distributions and reference token sequences over a large corpus of text data. The training process involves repeatedly performing forward propagation to compute token probability distributions given an input sequence, computing an error signal based on the loss function, and updating network parameters through backpropagation to reduce the loss. Data augmentation techniques such as random masking, sequence truncation, or noise injection may be used to improve generalization. The resulting trained generative AI model provides improved capability to generate coherent natural language responses given a prompt sentence.

When the server transmits the prompt sentence, the generative AI model tokenizes the input text into subword units, embeds them using learned embedding vectors, and processes them through attention-based layers that capture contextual dependencies between the garment article descriptions, meteorological information, and constraints included in the prompt sentence. The generative AI model then computes a sequence of output tokens representing outfit proposal information. The generation process uses model parameters such as temperature and top-k or nucleus sampling thresholds to balance determinism and diversity. The generative AI model does not apply fixed rule-based selection of items; instead, it uses the learned relationships between garment categories, weather conditions, and style constraints encoded in its parameter matrices, which yields outfit proposals that could not be obtained by simple manual rules.

The server receives the outfit proposal information in the form of generated natural-language text. Rather than forwarding this text directly to the terminal, the server converts it into structured component information. The server performs parsing of the generated text using deterministic text processing, pattern recognition rules, and optionally a secondary light-weight model. For example, the server maintains a mapping between known garment article identifiers and the textual labels used in the prompt sentence. The server identifies mentions of specific items, such as “blue shirt,” “black pants,” or “white sneakers,” by performing string matching and category tagging. The server then populates a structured record with fields such as top, bottom, footwear, outerwear, and accessory, each pointing to the corresponding garment article identifiers stored in the database.

By converting the generated text into component information, the server creates proposed outfit information that is machine-readable and normalized. This structure enables the server to store proposals as records in a database table and to perform operations such as deduplication, frequency counting, preference learning, and conflict detection. For example, the server can detect if a proposal includes an item tagged as “winter-only” in a high-temperature context and can flag the proposal for adjustment or re-generation. This normalization step constitutes a technical improvement over prior systems that treat AI-generated text as unstructured data.

The server generates proposed outfit information including upper-body article information, lower-body article information, footwear article information, and accessory article information. The server formats these fields into an internal representation suitable for transmission to the terminal and also generates control information that specifies how the proposed outfit information should be displayed. The control information may include layout templates, emphasis rules (for example, highlight weather-protection items in red during severe weather), and interaction metadata (for example, links or buttons for user feedback).

The server transmits both the proposed outfit information and the control information to the terminal.

The terminal receives the proposed outfit information and the control information, interprets the control information, and renders the proposed outfit information on the display. The terminal can display the items in separate sections, such as “Top,” “Bottom,” “Footwear,” and “Accessories,” and can show explanations generated by the generative AI model, such as:

“I recommend wearing the blue shirt with the black pants and white sneakers. The lightweight shirt and breathable pants are comfortable at 25° C., and the sneakers are suitable for a casual office. You can carry the gray cardigan in case the office air conditioning is cool.”

The term “explanation” here is a field derived from the generated text and formatted into a dedicated component, which the terminal displays as descriptive information. The user reads the proposal and explanation, and can then select actual garments accordingly.

The user can also provide evaluation information by interacting with user interface elements, such as “like,” “dislike,” or more granular rating options. The terminal encodes this evaluation information together with the identifier of the proposal and transmits it to the server. The server stores the evaluation information in the database and later uses it during prompt sentence generation. For example, when the server detects that the user consistently dislikes proposals containing certain colors or item types, the server adjusts its internal selection logic and modifies future prompt sentences to discourage those items. A representative prompt sentence incorporating such preference information can be:

“You are a fashion coordinator. The user dislikes very dark colors and avoids heavy boots except in cold or rainy conditions.

User's items: light blue shirt, beige chinos, navy cardigan, white sneakers, black boots.

Weather: mild, temperature 20° C., no rain.

Constraints: respect the user's dislike of very dark colors and heavy boots in mild weather. Propose one outfit using only the listed items and explain how it reflects the user's preferences.”

By embedding this user preference information directly into the prompt sentence, the server guides the generative AI model to produce proposals that align more closely with the user's tastes. This feedback loop shifts part of the learning burden from manual rule maintenance to automated adaptation through prompt engineering and preference-aware generation. At the same time, the server retains control over the data structures, storage, and selection rules, preventing the process from degenerating into an unstructured, purely subjective task. From a technical standpoint, the described configuration improves computer technology in several ways. The server constructs context-rich prompt sentences by algorithmically combining multiple data sources (garment article information, meteorological information, preference information, trend information, and so on) into a compact natural-language representation. This reduces the number of required network calls and the total size of transmitted data compared to naive approaches that would separately query for each factor or re-send redundant information. The normalization of generated outfit proposal information into structured component information enables efficient indexing, retrieval, and aggregation in the database, which improves query performance and reduces memory usage.

Furthermore, the use of a transformer-based generative AI model allows the system to implement non-linear, high-dimensional mappings between input context and output recommendations, which goes beyond human-curated rule sets. While conventional systems might apply a sequence of if-then rules such as “if temperature >25° C., avoid jackets,” the generative AI model implicitly captures more complex relationships (for example, combinations of humidity, wind, time of day, and user-specific sensitivity) without requiring exponential growth in rule count. This results in higher accuracy of outfit proposals under diverse conditions, and lowers the risk of logical inconsistency in edge cases.

The server-side processing steps, including tokenization of prompt sentences, mapping of generated tokens back to specific garment article identifiers, and storage of component information in normalized tables, are executed in a deterministic and optimized manner. The server can pre-compute partial prompt fragments, cache frequently used segments, and reuse them across multiple prompt sentences for different users. This caching and reuse reduces processing time and network load, thereby improving response latency. The combination of heavy computation at the generative AI model and targeted, optimized processing at the server achieves an efficient division of labor that is not achievable by purely rule-based systems or by unstructured use of AI-generated text.

The system does not simply automate a human stylist's manual decision-making. Instead, the system defines specific data structures, algorithms, and communication patterns that are adapted to the properties of transformer-based generative AI models and modern networked computing environments. For example, the server uses a non-conventional program flow in which user feedback not only adjusts local rule weights but is explicitly transformed into additional constraints and preference descriptions embedded in future prompt sentences. This approach leverages the generative AI model's capability for conditional generation in a way that standard recommendation engines do not.

In alternative embodiments, the server may host an on-premises generative AI model rather than relying on an external service. In such a case, the server includes a graphics processing unit or other accelerator hardware and executes model inference locally. The same prompt sentence generation and component extraction mechanisms apply, but the model execution occurs on the server's hardware. The server may also employ different neural network architectures, such as encoder-decoder architectures or recurrent neural networks, provided that they can process textual prompt sentences and output natural-language outfit proposals. In another variation, the terminal may perform a portion of the component extraction, using a lightweight neural network or rule-based parser implemented on the device. In that case, the server may send the raw or partially processed outfit proposal information to the terminal, and the terminal converts the text into structured component information before display. Such configurations may be chosen to optimize network bandwidth or server load in large-scale deployments.

In a further embodiment, the server uses time information and calendar information to schedule batch generation of proposals during off-peak hours. The server pre-computes next-day or multi-day outfit proposals using stored meteorological forecasts and user data, and distributes the proposals to terminals in advance. This reduces real-time computational demand during peak times and enhances perceived responsiveness from the user's perspective, thereby improving the technical performance of the overall system.

By integrating structured data management, context-rich prompt sentence generation, transformer-based generative AI modeling, and structured post-processing of AI outputs, the described system achieves improved precision, computational efficiency, and scalability in providing outfit proposals. These technical improvements are realized through specific hardware-software combinations and algorithmic flows running on the server and the terminal, and are not merely a direct automation of human fashion coordination tasks.

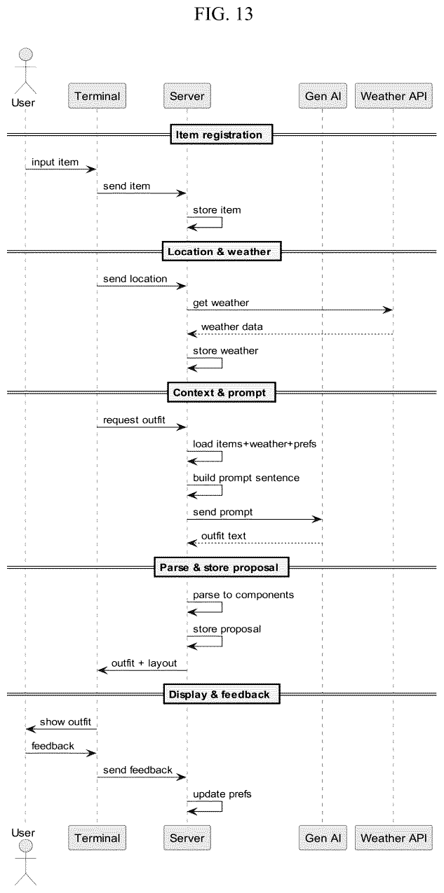

The following describes the processing flow using FIG. 13.

### Step 1:

The terminal displays an item registration screen to the user.

The terminal presents input controls (text fields, selection lists, image selectors) for garment category, color, seasonality, and style attributes.

Input: raw user actions on the terminal (taps, text entries, selections).

Output: a structured item description held in the terminal's working memory.

The terminal converts the user actions into a structured record (for example, category=upper-body, color=blue, season=summer) and stores this record in a local data structure ready for transmission.

### Step 2:

The user operates the terminal to enter garment article information.

The user selects a category (for example, top, bottom, footwear, accessory), inputs a text label such as “blue shirt,” optionally selects season tags, and confirms registration.

Input: the item registration screen displayed by the terminal and the user's intent to register an item.

Output: confirmed garment article information encoded in the terminal's internal format.

The user verifies the displayed information and triggers a save action, causing the terminal to finalize the item record.

### Step 3:

The terminal transmits the garment article information to the server.

The terminal packages the confirmed item record into a structured message and sends it via a network interface to a server-side endpoint over a secure protocol.

Input: the structured item description generated in Step 2.

Output: a network request message containing the item description.

The terminal serializes the item description into a standardized data format, attaches user identification data, and issues the request to the server.

### Step 4:

The server receives and validates the garment article information.

The server reads the incoming request from the network interface, parses the structured message, and checks for required fields and valid categories.

Input: the network request containing the garment article description.

Output: a validated item record stored in the server's memory.

The server performs data checks such as verifying category membership and filtering invalid characters, then constructs an internal object representing the item.

### Step 5:

The server stores the garment article information in a database.

The server writes the validated item record to a relational table with columns for user identifier, item identifier, category, attributes, and timestamps.

Input: the validated item record generated in Step 4.

Output: a persistent database entry for the garment article.

The server assigns a unique identifier to the item, inserts the record into the database, and updates any relevant indexes to support fast retrieval.

### Step 6:

The terminal acquires user location information.

The terminal calls an operating-system location service to obtain coordinates or a region identifier associated with the user.

Input: a request from the terminal application for current location.

Output: user location information (for example, latitude and longitude or city name) stored in the terminal.

The terminal reads the location from the system service, optionally converts it into a region identifier, and prepares it for transmission.

### Step 7:

The terminal transmits the user location information to the server.

The terminal constructs a request including the user identifier and location data and sends it over the network to the server.

Input: the user location information generated in Step 6.

Output: a location request message received by the server.

The terminal encodes the coordinates or city name, attaches the current time, and issues the request to a server endpoint designated for environmental data retrieval.

### Step 8:

The server obtains meteorological information from an external information source.

The server uses the user location information to construct a query for a meteorological data service and sends a request through the network interface.

Input: user location information received in Step 7.

Output: a meteorological data response from the external information source.

The server embeds the location parameters into a request format defined by the external service and forwards the request, then waits for a response.

### Step 9:

The server parses and stores the meteorological information.

The server reads the meteorological data response, extracts numerical values (such as temperature, humidity, and wind speed) and categorical descriptors (such as “clear sky” or “heavy rain”), and stores them in a database.

Input: the meteorological data response obtained in Step 8.

Output: normalized meteorological records associated with the user.

The server maps each raw field from the response into typed fields in a meteorological table, associates the record with the user identifier and time, and writes the record to persistent storage.

### Step 10:

The server retrieves garment article information and meteorological information for a proposal.

The server issues database queries to obtain all active garment items registered by the user and the most recent meteorological record for the user's location.

Input: the user identifier and a request to generate an outfit proposal.

Output: an internal composite data structure containing garment article information and meteorological information.

The server executes join and filter operations in the database, collects the results into memory, and organizes them into a unified context object.

### Step 11:

The server incorporates additional context information for personalization and trends.

The server retrieves user preference information, evaluation information for past proposals, time information, calendar information, trend information, and purchase-related information from storage.

Input: the user identifier and the composite context object from Step 10.

Output: an augmented context object including preferences, feedback, time, and trend data.

The server merges the additional records with the existing context object, resolves conflicts (such as outdated preferences), and constructs a coherent set of context parameters for use in generation.

### Step 12:

The server generates a structured representation for prompt construction.

The server converts the augmented context object into an internal representation that separates categories such as user items, weather, preferences, and constraints.

Input: the augmented context object produced in Step 11.

Output: a structured prompt context containing categorized lists and attributes.

The server groups items by garment category, applies filters (for example, remove out-of-season items when weather is extreme), and computes summary descriptors (such as “hot and humid evening” based on raw meteorological data).

### Step 13:

The server constructs a prompt sentence for the generative AI model.

The server assembles text segments for role definition, item lists, weather description, user preferences, constraints, and situational information and concatenates them according to a template.

Input: the structured prompt context produced in Step 12.

Output: a prompt sentence in natural language ready for submission to the generative AI model.

The server converts each data field into a human-readable phrase, orders the phrases to minimize ambiguity, and combines them into a single string. For example, the server generates:

“You are a fashion coordinator. Use only the user's items listed below and consider the weather and situation.

User's items: blue shirt (top), black pants (bottom), white sneakers (shoes), gray cardigan (outerwear).

Weather: clear sky, temperature 25° C., light wind, no rain expected.

Situation: casual office during the day.

Constraints: use only the listed items; choose one top, one bottom, one pair of shoes, and optionally outerwear.

Propose one recommended outfit and briefly explain why it suits the weather and situation.” Step 14:

The server transmits the prompt sentence to the generative AI model.

The server wraps the prompt sentence into a model invocation request and sends it to the generative AI model endpoint via the network interface.

Input: the prompt sentence generated in Step 13.

Output: a model invocation message accepted by the generative AI model.

The server embeds the prompt sentence as a text field in the request, sets model parameters such as maximum output length and temperature, and sends the request over a secure connection.

### Step 15:

The server receives the outfit proposal information from the generative AI model. The generative AI model processes the prompt sentence and returns generated natural-language text representing at least one outfit proposal and an explanation.

Input: the model invocation request sent in Step 14.

Output: an outfit proposal response message containing generated text.

The server reads the response from the network, extracts the generated text field, and stores it temporarily in memory for further processing.

### Step 16:

The server converts the outfit proposal information into component information.

The server parses the generated text to identify references to specific garment items and categories and maps them to stored item identifiers.

Input: the generated natural-language text received in Step 15 and the garment article information stored in the database.

Output: structured component information identifying selected upper-body, lower-body, footwear, and accessory items.

The server performs text matching between item names in the generated text and known item names in the user's garment list, assigns each referenced item to a category field, and constructs a component record with explicit category-to-item associations.

### Step 17:

The server generates proposed outfit information from the component information.

The server organizes the component information into a normalized record that includes category fields, item identifiers, and explanatory text.

Input: the structured component information produced in Step 16.

Output: a proposed outfit record suitable for storage and display.

The server copies the explanation portion of the generated text into a description field, sets references to the selected items for each category, and applies consistency checks (for example, ensuring that only one main top and one main bottom are selected).

### Step 18:

The server stores the proposed outfit information and associated metadata.

The server writes the proposed outfit record, including timestamps, user identifier, meteorological conditions, and model invocation parameters, into a dedicated table.

Input: the proposed outfit record from Step 17.

Output: a persistent proposal entry in the database.

The server inserts the record into storage, updates indexes for quick retrieval by date or weather condition, and associates a proposal identifier with the record.

### Step 19:

The server generates control information for presentation on the terminal.

The server determines layout type, emphasis rules, and interaction elements for the proposed outfit and encodes them in a control structure.

Input: the proposed outfit record from Step 17 and display policy rules stored on the server.

Output: control information describing how the proposal should be rendered on the terminal.

The server selects a display template based on context (for example, highlight weather-protection items when precipitation probability is high) and populates the template with references to the proposed items and explanation.

### Step 20:

The server transmits the proposed outfit information and control information to the terminal.

The server constructs a response message that contains both the normalized proposal data and the associated control structure and sends it through the network interface.

Input: the proposed outfit record and control information from Steps 17 and 19.

Output: a response message delivered to the terminal.

The server encodes the fields into a standardized format, attaches user and proposal identifiers, and issues the response over a secure channel.

### Step 21:

The terminal receives and interprets the proposed outfit information and control information.

The terminal parses the response message, extracts category fields, item references, explanation text, and display instructions, and prepares user interface elements accordingly.

Input: the response message received from the server in Step 20.

Output: an internal representation of the proposal ready for rendering.

The terminal maps each category field (top, bottom, footwear, accessories) to UI sections and associates item references with local image resources if available.

### Step 22:

The terminal displays the proposed outfit information to the user.

The terminal renders text labels, images, and explanation text according to the control information and displays them on the screen.

Input: the internal representation of the proposal and the control information from Step 21.

Output: a visual presentation of the recommended outfit on the display.

The terminal arranges the UI sections, applies any highlighting rules (for example, bolding items critical for weather protection), and shows the explanation text beneath the item list.

### Step 23:

The user reviews the proposal and optionally provides evaluation information. The user reads the displayed outfit, compares it against personal preferences and available garments, and may interact with rating or feedback controls on the terminal.

Input: the visual presentation of the proposal displayed in Step 22.

Output: a user feedback action, such as a rating or preference adjustment.

The user taps a “like,” “dislike,” or other feedback button, or selects options indicating reasons (for example, “too formal,” “colors not preferred”).

### Step 24:

The terminal transmits evaluation information to the server.

The terminal encodes the user's feedback, including the proposal identifier and any selected reason codes, and sends this evaluation information to the server.

Input: the user feedback action captured in Step 23.

Output: a feedback message delivered to the server.

The terminal constructs a structured record of the evaluation data and sends it over the network using a designated endpoint for feedback submission.

### Step 25:

The server stores and utilizes the evaluation information for future prompt sentences.

The server records the feedback in a preference and evaluation table and later incorporates this data when building new structured prompt contexts.

Input: the feedback message received in Step 24.

Output: updated user preference and evaluation records stored in the database and available for subsequent proposal generation.

The server analyzes the feedback to adjust preference weights (for example, decrease the weight of frequently rejected colors or item types), updates the context used in prompt construction, and thereby influences the generation of future prompt sentences and outfit proposals.

### Application Example 2

Description follows regarding a flow of the specific processing in an Application Example 2. The units of the system described below are implemented by the data processing device 12 and the smart device 14. The data processing device 12 is called a “server” and the smart device 14 is called a “terminal”.

Conventional outfit recommendation systems typically treat weather data, user item data, and user mood or preference data as loosely connected inputs that are processed in separate modules or by static rule sets. In many implementations, a server simply retrieves weather information, retrieves a list of user-registered items, and applies predetermined rules or a generic machine learning model to select items. Such systems often lack a unified context representation and do not adapt the internal processing pipeline based on real-time user feedback, psychological state, or actual user selections. As a result, the systems tend to generate recommendations that are repetitive, poorly aligned with individual user preferences, and insensitive to the user's changing emotional state.

From the standpoint of computer technology, existing systems generally pass unstructured or weakly structured data to a recommendation engine and treat the output as opaque text or a fixed set of items. The server does not systematically construct machine-readable instruction text that reflects combined context (weather, user psychological state, usage history, and inventory), nor does it parse the output into normalized, structured data that can be reused by downstream components such as inventory management, navigation, or feedback learning modules. Consequently, the server cannot efficiently optimize its internal data flows, cannot reliably map recommended items back to stored item records, and cannot systematically update its own behavior based on prior interactions.

Furthermore, known systems that use generative AI models typically invoke such models in an ad-hoc manner, with manually crafted prompts that are not dynamically adapted based on machine-learned preference history or user interaction history. The server therefore fails to exploit the generative AI model as a programmable, context-aware component in a larger computation pipeline. The absence of a feedback loop, in which the server automatically aggregates selection results and evaluation data and then modifies its prompt generation and output utilization logic, leads to inefficient use of computing resources and suboptimal personalization.

In addition, existing architectures do not tightly integrate merchandise information and acquisition procedure information into the core recommendation computation. When a generative AI model outputs a textual suggestion, the server often handles the text purely as a human-readable message, without mapping it to structured merchandise data and without attaching machine-processable acquisition or navigation data. This separation forces additional manual or semi-manual processing if the system is to support in-store navigation, online purchasing, or automatic inventory filtering, and prevents the system from achieving an end-to-end, machine-driven workflow.

Accordingly, there is a need for a technical framework in which a processor centrally manages wearer-related article information, weather condition data, and user psychological state information; dynamically generates and refines instruction text (prompt sentences) for a generative AI model based on such integrated context and learned preference history; converts the resulting model output into structured proposal data tightly linked with stored item and merchandise information; and iteratively updates its own internal models and control logic based on user selections and evaluations. Such a framework should improve the efficiency, robustness, and adaptability of the server-side computation, thereby providing a concrete improvement in the functioning of the computer system itself rather than merely automating a human decision process.

The specific processing by the specific processing unit 290 of the data processing device 12 in Application Example 2 is realized by the following means.

The present invention provides a server comprising a processor and a memory, the processor being configured to store and update, in the memory, wearer-related article information representing articles to be worn possessed by a user; to acquire weather forecast information from an external information providing apparatus and hold the acquired information as weather condition data; to calculate and accumulate user psychological state information based on user input and information obtained from an imaging apparatus and a voice acquiring apparatus; to dynamically generate, on the basis of the wearer-related article information, the weather condition data, the psychological state information, and preference history information of the user, a prompt sentence serving as instruction text for a generative AI model, and to transmit the prompt sentence to the generative AI model; to receive output text from the generative AI model, analyze the output text, and convert the analyzed output text into structured proposal data associated with the wearer-related article information and merchandise information; to generate, on the basis of the structured proposal data, an outfit proposal adapted to a weather condition and a psychological state of a current day of the user, and output display data representing the outfit proposal to a user information processing terminal; to add acquisition procedure information to articles included in the outfit proposal on the basis of the merchandise information and transmit the acquisition procedure information to the user information processing terminal; to receive selection result information and evaluation information of the user transmitted from the user information processing terminal, and accumulate the selection result information and the evaluation information in the memory as the preference history information; and to update contents of generation of the prompt sentence and a utilization method of the output of the generative AI model by using the preference history information so as to perform individual optimization of subsequent outfit proposals. This enables the server to implement an integrated, feedback-driven computation pipeline in which contextual data are unified into dynamically generated machine-readable instruction text, generative AI outputs are normalized into structured, machine-processable proposal data, and the internal behavior of the recommendation engine is continuously adapted based on accumulated interaction history, thereby improving the efficiency, accuracy, and technical performance of the computer system in generating and delivering personalized outfit proposals.

The term “wearer-related article information” refers to digital data representing attributes of articles to be worn possessed by a user, including at least a classification of the article, a color, a material, a size, and an identifier associating the article with the user.

The term “weather forecast information” refers to data received from an external information providing apparatus that indicates predicted atmospheric conditions for a place and a time, including at least a temperature, a precipitation condition, and a weather condition type.

The term “weather condition data” refers to normalized, stored data derived from weather forecast information, and representing weather-related parameters used by the server for computation of recommendations.

The term “user psychological state information” refers to data representing a mental or emotional state of a user, the data being calculated from at least one of explicit user input, image data of the user, and audio data of the user.

The term “preference history information” refers to data accumulated over time that represents tendencies of a user with respect to selection, evaluation, and usage of articles, including at least outfit selection history, evaluation information, purchase history, and usage frequency information.

The term “prompt sentence” refers to instruction text generated by the processor and supplied as input to a generative AI model, the instruction text describing contextual conditions and desired output constraints in natural language or a structured textual format.

The term “generative AI model” refers to an information processing model implemented by software and hardware that generates textual output in response to input text, based on parameters learned from training data, and that can produce proposals or explanations according to a received prompt sentence.

The term “output text” refers to text data generated by the generative AI model in response to a prompt sentence, the text data including at least a description of a recommended outfit or article combination.

The term “structured proposal data” refers to machine-processable data obtained by analyzing output text from the generative AI model, the data being organized in a normalized format that associates individual recommended articles with internal identifiers and attributes.

The term “merchandise information” refers to data representing articles that are available for acquisition from a sales entity, including at least a product identifier, a classification, a price, an availability status, and optional location information within a sales facility.

The term “outfit proposal” refers to a set of one or more articles to be worn, selected and combined by the server on the basis of structured proposal data, and adapted to at least a weather condition and a psychological state of a user.

The term “display data” refers to data formatted for presentation on a user information processing terminal, the data including at least identifiers of recommended articles and textual or graphical information describing an outfit proposal.

The term “acquisition procedure information” refers to data that enables a user to acquire an article included in an outfit proposal, the data including at least one of a link for online acquisition, ordering parameters, or guidance to a physical sales location.

The term “selection result information” refers to data indicating a result of a user's selection operation with respect to an outfit proposal or a recommended article, including at least approval, rejection, or actual acquisition of an article.

The term “evaluation information” refers to data representing an assessment by a user regarding an outfit proposal or a recommended article, including at least rating values, preference indications, or textual comments.

The term “user information processing terminal” refers to an electronic apparatus operated by a user and configured to communicate with the server, including at least a display device, an input interface, and a communication interface.

The term “external information providing apparatus” refers to an information processing system that supplies data to the server via a communication network, including at least a system that provides weather information, trend information, or other contextual data.

The term “trend information” refers to data representing current or predicted popularity of styles, colors, or article types within a time period, obtained from an external trend information providing apparatus or an internal analysis process.

The term “seasonal information” refers to data indicating a season derived from calendar information or environmental information, the data being used to bias or filter outfit proposals according to a time of year.

The term “sales location guidance information” refers to data indicating a position or region within a physical sales facility where a recommended article can be obtained, including at least a section identifier, an area designation, or map coordinates.

The term “position information of the user” refers to data indicating a geographical location or an indoor position of a user, obtained by at least one of a satellite positioning system, a wireless communication system, or an indoor positioning system.

The term “instruction text” refers to textual data provided to a generative AI model to control processing by the model, and includes the prompt sentence and any additional context or formatting constraints.

In one embodiment, a server cooperates with one or more terminals used by a user to implement the claimed system. The server includes at least one processor, a main memory, a persistent storage device such as a relational database, and a network interface. The terminal includes a processor, a memory, a display, an input interface such as a touch screen or physical buttons, an imaging apparatus such as an integrated camera, and a voice acquiring apparatus such as a microphone. The server executes application software implemented, for example, in a general-purpose programming language such as Python, Java, or a similar language, and uses framework software such as a relational database management system, a network communication stack, and a machine learning framework.

The server stores wearer-related article information, weather condition data, user psychological state information, preference history information, and merchandise information in a structured manner. The server uses a relational database system, such as a general SQL database, to maintain tables including a user table, an article table, a weather table, a psychological_state table, a preference_history table, and a merchandise table. Each table is indexed using primary keys and secondary indices so that the processor can retrieve context data with low latency when generating a prompt sentence for a generative AI model.

The terminal enables the user to register articles to be worn. The user operates the terminal to capture an image of clothing, footwear, bags, or accessories with the camera. The terminal presents input fields for attributes such as category (for example, top, bottom, footwear, outerwear, accessory), color, material, size, and optional tags describing style (for example, casual, formal, sporty). The terminal forms a data structure containing a user identifier, an article identifier, image metadata, and the attribute values, and transmits this data structure to the server through a secure communication channel such as HTTPS. The server receives the article data, normalizes categorical attributes using lookup tables stored in the database (for example, mapping “light blue” and “sky blue” into a unified color category), and writes a record into the article table. By normalizing attributes, the server reduces variability in input values and improves the accuracy and speed of subsequent matching and retrieval operations.

The server acquires weather forecast information from an external information providing apparatus, such as a general weather information system, via an application programming interface. The server transmits an HTTP request with parameters including geographic coordinates or a location identifier. The external system returns weather forecast information in a structured response such as JSON. The server parses the response, extracts predicted temperature, precipitation probability, precipitation type, wind speed, and weather condition codes, and converts the units into a standardized internal representation. The server stores these values as weather condition data in the weather table, associated with a time stamp and a location key. The server uses indexing by time and location so that it can retrieve the most relevant weather condition data when constructing a prompt sentence.

The terminal acquires user psychological state information in different ways. In one embodiment, the user explicitly selects an emotion label such as “happy,” “sad,” “stressed,” or “relaxed” from a list displayed on the terminal, or inputs free-form text such as “I feel anxious today” or “I want a relaxed mood.” In another embodiment, the terminal uses the camera to capture a facial image and uses image processing software, for example, a library such as a general computer vision library, to detect facial landmarks and facial expressions. The terminal uses the microphone to record voice data and may use a speech-to-text module and sentiment analysis routine to estimate affect from the speech content and prosody. The terminal converts the detected affect into numerical features, such as a vector representing probabilities over emotion classes and intensity scores, and sends this data to the server as user psychological state information.

The server receives the psychological state information, stores it in the psychological_state table, and may also maintain a current_emotion field in the user table to facilitate low-latency access. The server optionally aggregates multiple emotion estimates over a recent time window to compute a smoothed psychological state, for example by applying an exponential moving average on emotion probability vectors. This smoothing reduces noise from short-term fluctuations and provides a more stable context for generating outfit proposals.

The server maintains preference history information by recording user selection results and evaluation information over time. When the terminal displays an outfit proposal and the user approves, rejects, purchases, or otherwise interacts with recommended articles, the terminal transmits selection result information and evaluation information to the server. The server stores each interaction in the preference_history table, linking it to the user identifier, article identifiers, weather condition data, psychological state information, and the prompt sentence used at the time. The server then periodically processes the preference history using a machine learning framework such as a general tensor-based framework or a general deep learning library.

The server computes preference feature information from the preference history information. In one embodiment, the server represents each article and each user as a vector in a latent feature space, and trains a model that predicts a rating or selection probability given a user vector and an article vector. The server may use a neural network architecture that receives as input concatenated features: (1) categorical encodings of article category, color, material, and brand; (2) numerical features such as temperature range in which the article was worn; and (3) psychological state features such as emotion probabilities at the time of selection. The server trains this model by minimizing a loss function such as a mean squared error or a cross-entropy loss between predicted ratings and actual user feedback. The server updates model parameters using an optimization algorithm such as stochastic gradient descent or an adaptive variant. As a result, the server obtains preference feature information that encodes, for example, that a particular user tends to prefer neutral colors in cold weather, avoids bright red when stressed, and frequently chooses sneakers over formal shoes.

The server dynamically generates a prompt sentence as instruction text for a generative AI model. The server retrieves the wearer-related article information for the user, the relevant weather condition data, the current or recent psychological state information, and the computed preference feature information. The server summarizes this information as compact textual descriptors. For example, the server may generate sentences such as “The user's closet includes: navy blazer, white T-shirt, gray hoodie, black jeans, white sneakers.” The server may also include preference descriptions such as “The user usually prefers neutral colors and simple casual style, and often selects sneakers.” The server then composes a prompt sentence that instructs the generative AI model how to generate an outfit proposal under given constraints.

The server, for example, may construct a prompt sentence as follows:

“Today's weather is rainy with a temperature of 10° C. The user will go to the office and prefers a casual style. The user's current emotion is ‘stressed’ and the user wants a relaxed outfit. The user usually prefers neutral colors and simple casual style, and often selects sneakers. The user's registered items include: navy blazer, white T-shirt, black jeans, white sneakers, gray hoodie. Based on this information, please propose a comfortable and office-appropriate coordination for today, specifying which registered items to use and briefly explaining why they are suitable.”

In another example, the server may generate a prompt sentence that uses purchase history and trend information:

“The user's past purchase history includes a black jacket and a white shirt. Spring trends favor light-wash denim and pastel accents. The weather forecast for tomorrow is sunny and 24° C. Please propose a spring coordination using the black jacket and the white shirt, and suggest suitable pants and shoes that match current trends and can be complemented by items similar to light-wash denim and pastel colors.”

By generating the prompt sentence programmatically, the server converts multiple heterogeneous data sources into a unified, machine-readable instruction text that the generative AI model can interpret. This approach improves the utilization of the generative AI model as a controllable computation component rather than a black-box text generator.

The server interacts with a generative AI model that is implemented as a neural network, for example a transformer-based language model. The generative AI model includes multiple layers of self-attention and feed-forward neural network blocks, each with learnable weight matrices and non-linear activation functions. The model has been pre-trained on large text corpora and may be optionally fine-tuned on domain-specific text, such as fashion descriptions or coordination examples. The server sends the prompt sentence to the model via an application programming interface, specifying parameters such as a maximum number of tokens and a sampling temperature. The model tokenizes the prompt, applies internal computations including attention weight computation, linear transformations, and activation, and outputs a sequence of tokens representing output text. The server receives the output text as part of a response payload.

The server analyzes the output text to create structured proposal data. To do this, the server may instruct the generative AI model, via the prompt sentence, to output in a constrained format, for example with clear labels for “Top:”, “Bottom:”, “Outer:”, and “Shoes:”. The server then parses the output using pattern matching or natural language processing to extract article descriptions and explanation sentences. The server maps each textual article description to one or more article records stored as wearer-related article information or merchandise information. The server may perform this mapping using exact string matching, normalized name matching, and, if necessary, an embedding-based similarity search provided by a vector search library or database. The server then constructs structured proposal data entries, each including a reference to an internal article identifier, category, color, and an optional score representing relevance or confidence.

The server associates acquisition procedure information with articles in the structured proposal data. For wearer-owned articles, the acquisition procedure information may simply indicate that no purchase is required. For merchandise articles, the server retrieves product identifiers, price, availability status, and location within a physical store from the merchandise table. The server adds data such as a universal resource locator for an online store, or concise guidance such as “Men's casual section, aisle 3” for a physical store. The server packages the outfit proposal, article details, explanations, and acquisition procedure information into display data designed for the terminal.

The terminal receives the display data from the server and renders an interface showing the outfit proposal. The terminal displays, on the screen, images and textual descriptions of each article, along with explanation text describing how the coordination fits the weather condition data and the user psychological state information. The terminal renders interactive elements that allow the user to indicate approval, disapproval, or selection of specific articles, and to access acquisition procedure information. When the user selects a purchase link, the terminal opens a browser or an in-app view to the corresponding sales system.

The server benefits from this architecture by improving internal data management, calculation efficiency, and response quality. Because the server converts dispersed contextual data into a single prompt sentence with defined structure, the generative AI model receives a fully specified problem state and produces more relevant and consistent output. This reduces the need for post-hoc corrections and re-queries, thereby reducing communication load and processing time. The structured proposal data format enables the server to index and reuse generative outputs in a normalized database, which improves data consistency and enables fast queries for logging, analytics, and incremental learning. The feedback loop, in which the server continuously updates preference history information and preference feature information, allows the server to refine prompt sentence content and post-processing heuristics, yielding higher precision and lower error rates in subsequent recommendations. The system does more than simply automate human decision making. A human stylist typically cannot integrate real-time weather forecasts, long-term selection statistics, emotion estimates from sensor data, and large-scale merchandise catalogs in a consistent, low-latency manner. The server, by contrast, executes a non-conventional sequence of operations: (1) normalization of heterogeneous sensor and context data into specific feature vectors and textual descriptors; (2) dynamic construction of prompt sentences encoding both hard constraints (for example, only registered items) and soft preferences (for example, style tendencies); (3) constrained generation by a neural generative model; and (4) deterministic parsing and re-mapping of unstructured output into structured proposal data. These steps, implemented as persistent machine-executable logic, result in technical improvements at the level of data flow, storage, and processing.

In one variation, the server uses a fine-tuning pipeline to adapt the generative AI model to domain-specific prompts and outputs. The server collects pairs of prompt sentences and accepted outfit proposals, and uses these pairs as training data. The server computes loss values such as a cross-entropy between generated tokens and target tokens, and uses gradient-based optimization to update model parameters. As the model becomes more aligned with the system's structured prompt sentences, the average length and ambiguity of the output text may decrease, which simplifies the parser, reduces computational cost, and further lowers latency and error probability.

In another embodiment, the server uses different prompt templates depending on scenario types, such as home coordination, office coordination, event coordination, and in-store guidance. The server selects a template and injects variable fields such as weather condition data, user psychological state information, and preference feature information. For example, for a weekend relaxed outfit, the server may use a prompt sentence including:

“The user wants a relaxed weekend outfit for staying at home. The user's emotional state is stressed and the user prefers soft fabrics and loose silhouettes. From the registered items, please propose a comfortable, relaxing coordination and briefly explain why it is suitable.” By explicitly encoding style constraints and user psychological state in this form, the server reduces the search space that the generative AI model must explore, leading to faster and more focused generation.

In yet another embodiment, the server integrates seasonal information and trend information. The server retrieves seasonal information from calendar data and trend information from an external trend information providing apparatus. The server then includes sentences such as “Spring trends emphasize light colors and minimalist silhouettes” in the prompt sentence. This integration allows the generative AI model to adapt its proposals to current fashion tendencies without modifying the core architecture. The server's structured handling of such context reduces repeated manual updates and ensures that time-varying factors are systematically incorporated into recommendation computation.

The system architecture is not limited to a single implementation. The server may be implemented as a cluster of computing nodes, with separate modules for context aggregation, prompt generation, generative model interaction, output parsing, and feedback learning. Each module may run as a container or a microservice, communicating over an internal network. The generative AI model may be hosted by a third-party provider or by the operator of the server, and may run on specialized hardware such as graphics processing units or tensor processing units. The terminal may be a smartphone, a tablet, a wearable device such as smart glasses, or a personal computer. The imaging apparatus may be an integrated camera or an external camera, and the voice acquiring apparatus may be an integrated microphone or an external audio device.

The described embodiments illustrate how the server, the terminal, and the generative AI model cooperate to realize the functions recited in the claims. The server manages structured wearer-related article information, weather condition data, user psychological state information, preference history information, and merchandise information; the server converts these data into carefully designed prompt sentences; the generative AI model generates output text under these constraints; and the server converts the output text into structured proposal data linked to internal records and user interfaces. By designing the computation pipeline, data structures, and model interaction rules in this way, the invention provides a concrete improvement in computer technology related to context-aware recommendation, data management, and neural text generation.

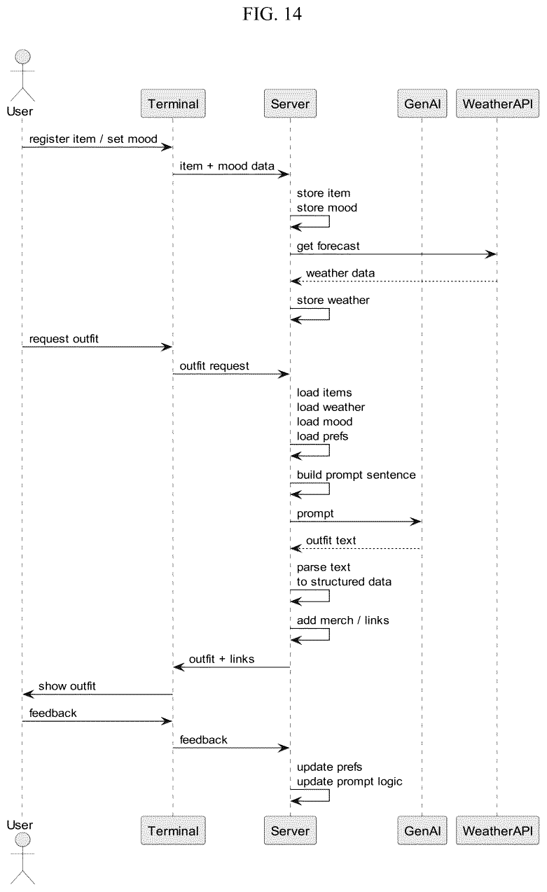

The following describes the processing flow using FIG. 14.

### Step 1:

User operates the terminal to register wearer-related articles.

Terminal receives as input image data captured by a camera and attribute data (category, color, material, size, style tags) entered through a touch interface. Terminal converts these inputs into a structured data record including a user identifier, an article identifier, and normalized attribute values. Terminal transmits the record to the server via a network connection (for example, HTTPS). The output of this step is a formatted article registration request sent to the server.

### Step 2:

Server processes the article registration request and stores wearer-related article information.

Server receives as input the structured article data from the terminal. Server validates mandatory fields, checks data types, and performs normalization by mapping free-text attributes to controlled vocabularies (for example, mapping “tee” and “T-shirt” to a standard category code). Server writes the normalized data into an article table in a relational database, creating or updating rows keyed by user identifier and article identifier. The output of this step is a persistent wearer-related article record stored in the database and an acknowledgment message returned to the terminal.

### Step 3:

Server acquires and stores weather forecast information.

Server receives as input a location key (such as coordinates or region identifier) associated with the user and a time context (such as current time or planned usage time). Server issues an API request to an external weather information provider and receives weather forecast information as a structured response. Server parses the response, extracts temperature, precipitation probability, precipitation type, wind speed, and condition codes, and converts units into an internal standardized format. Server then inserts or updates a record in a weather table indexed by user identifier or location and time. The output of this step is weather condition data stored in the database and available for later retrieval.

### Step 4:

Terminal acquires user psychological state information.

User provides as input either an explicit selection of an emotion label, a free-text description of mood, or sensor data captured by the terminal's camera and microphone. Terminal acquires facial image frames and/or audio segments and runs local or remote emotion analysis routines, which compute features such as emotion probabilities (for example, happy, sad, stressed) and intensity scores. Terminal packages the emotion label, feature vector, and optional user text into a psychological state data structure. The output of this step is psychological state information transmitted from the terminal to the server.

### Step 5:

Server stores and refines user psychological state information.

Server receives as input the psychological state data structure from the terminal. Server writes this information into a psychological_state table associated with the user identifier and a time stamp. Server optionally applies a smoothing algorithm, such as an exponential moving average over recent emotion vectors, to reduce noise and compute a refined current emotional state. Server writes the refined state into a current_emotion field in the user table. The output of this step is an updated, stable representation of the user psychological state stored in the database.

### Step 6:

Terminal displays outfit proposals history and collects feedback.

User views on the terminal previously generated outfit proposals and provides as input explicit reactions such as “like,” “dislike,” rating stars, or selection of specific items actually worn or purchased. Terminal converts these interactions into selection result information and evaluation information, including proposal identifiers, article identifiers, and feedback values. Terminal sends this information to the server. The output of this step is structured preference feedback data transmitted to the server for learning.

### Step 7:

Server updates preference history information.

Server receives as input selection result information and evaluation information from the terminal. Server writes each entry into a preference_history table, referencing user identifier, article identifiers, weather condition data, psychological state information, and the prompt sentence used for the corresponding proposal. Server may aggregate statistics such as selection frequency per article, approval rate per color or style, and success rate under specific weather or emotional conditions. The output of this step is updated preference history information available for later model training and prompt customization.

### Step 8:

Server trains or updates a preference model.

Server receives as input accumulated preference history information and wearer-related article attributes. Server constructs feature vectors for training by combining article attributes, context features (weather condition data, psychological state information), and target labels derived from user evaluations (for example, accepted vs. rejected). Server uses a machine learning framework to train a neural network or similar model, minimizing a loss function such as cross-entropy between predicted and actual user decisions. Server updates model parameters iteratively using an optimization algorithm. The output of this step is a trained preference model and derived preference feature information for each user and article.

### Step 9:

Server aggregates current context for recommendation.

Server receives as input a recommendation request, which may be triggered by user action on the terminal or by a scheduled event. Server retrieves relevant wearer-related article information from the article table, the latest weather condition data from the weather table, the refined psychological state information from the user and psychological_state tables, and the preference feature information from the trained model or a feature store. Server filters the article set to those suitable for the current weather and usage context (for example, excluding sandals in cold weather), and ranks or groups items based on preference scores. The output of this step is a structured context package containing selected articles, weather condition data, psychological state information, and preference summaries.

### Step 10:

Server generates a prompt sentence for a generative AI model.

Server receives as input the structured context package from Step 9. Server converts article sets into concise textual lists (for example, “navy blazer, white T-shirt, black jeans, white sneakers, gray hoodie”), converts weather condition data into descriptive phrases (for example, “rainy and 10° C.”), and converts psychological state information and preference feature information into natural-language summaries (for example, “the user is feeling stressed and usually prefers neutral colors and simple casual style”). Server then programmatically concatenates these components into a prompt sentence. For example, server may output:

“Today's weather is rainy with a temperature of 10° C. The user will go to the office and prefers a casual style. The user's current emotion is ‘stressed’ and the user wants a relaxed outfit. The user usually prefers neutral colors and simple casual style, and often selects sneakers. The user's registered items include: navy blazer, white T-shirt, black jeans, white sneakers, gray hoodie. Based on this information, please propose a comfortable and office-appropriate coordination for today, specifying which registered items to use and briefly explaining why they are suitable.”

The output of this step is a fully formed prompt sentence text ready to be sent to the generative AI model.

### Step 11:

Server calls the generative AI model and obtains output text.

Server receives as input the prompt sentence produced in Step 10. Server constructs an API request payload including the prompt sentence and generation parameters such as maximum token count and sampling temperature. Server transmits the request to a generative AI model endpoint over a network interface. The generative AI model internally tokenizes the prompt and performs neural network computations to generate a sequence of tokens representing an outfit proposal and explanation. Server receives the response, extracts the generated text, and logs the association between the prompt sentence and the output text. The output of this step is output text describing a recommended outfit combination and reasoning.

### Step 12:

Server converts output text into structured proposal data.

Server receives as input the output text generated by the generative AI model. Server parses the text using predetermined patterns or natural language processing, detecting labeled parts such as “Top:”, “Bottom:”, “Outer:”, and “Shoes:”, or equivalent phrases. Server extracts article descriptions and explanation segments and attempts to map each described item to a wearer-related article record or merchandise record by comparing normalized names and attributes, optionally using similarity search if the names are approximate. Server then constructs structured proposal data entries that link each recommended slot (top, bottom, outerwear, footwear, accessory) to a specific internal article identifier and include the explanation text. The output of this step is a structured proposal data set representing the outfit proposal in a machine-processable format.

### Step 13:

Server attaches acquisition procedure information to proposal data.

Server receives as input the structured proposal data from Step 12 and merchandise information stored in the database. For recommended articles that correspond to merchandise entries, server retrieves product identifiers, price, stock status, and location within a sales facility. Server constructs acquisition procedure information such as online purchase links and in-store navigation hints. For items already owned by the user, server may mark the acquisition procedure as “owned; no purchase required.” The output of this step is an enriched outfit proposal including article references, explanations, and acquisition procedure information.

### Step 14:

Server generates display data for the terminal.

Server receives as input the enriched outfit proposal from Step 13. Server formats this information into a display data structure including article images or image URLs, names, categories, explanation sentences, and user interface metadata (for example, buttons for “like,” “dislike,” and “purchase”). Server may also include contextual text summarizing weather condition data and psychological state information used in the proposal. The output of this step is display data ready to be rendered on the user information processing terminal.

### Step 15:

Terminal presents the outfit proposal and captures user interaction.

Terminal receives as input the display data from the server. Terminal renders the outfit proposal on the screen, showing images and descriptions for each recommended article, as well as textual explanations. Terminal presents interactive controls that allow the user to approve or reject the overall proposal, select specific articles, and trigger acquisition procedures (for example, opening a purchase link). When the user operates these controls, the terminal records the interaction as selection result information and evaluation information. The output of this step is updated user interaction data that the terminal sends back to the server for storage in the preference history and for use in future iterations of the process.

### Step 16:

Server updates prompt generation and model utilization based on feedback.

Server receives as input the user interaction data from Step 15, including which proposals were accepted, which articles were selected, and any direct ratings or comments. Server updates the preference_history table and recomputes or refines preference feature information. Server then adjusts rules and templates used in Step 10, such as increasing emphasis on frequently accepted colors or de-emphasizing styles often rejected under certain psychological states. Server may also adjust generation parameters (for example, sampling temperature) or output parsing rules to reduce ambiguity in future outputs. The output of this step is an updated set of internal parameters and prompt sentence generation logic that will influence subsequent recommendation cycles.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Moreover, although the processing by the data processing system 10 described above was executed by the specific processing unit 290 of the data processing device 12 or by the control unit 46A of the smart device 14, the processing may be executed by a specific processing unit 290 of the data processing device 12 and a control unit 46A of the smart device 14. Moreover, the specific processing unit 290 of the data processing device 12 acquires and collects information needed for processing from the smart device 14 or from an external device or the like, and the smart device 14 acquires and collects information needed for processing from the data processing device 12 or from an external device or the like.

For example, a collection unit is implemented by the control unit 46A of the smart device 14 and/or by the specific processing unit 290 of the data processing device 12. For example, an acquisition unit acquires number-of-steps data using the camera 42 and/or the communication I/F 44 of the smart device 14, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the output device 40 of the smart device 14 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart device 14.

### Second Exemplary Embodiment

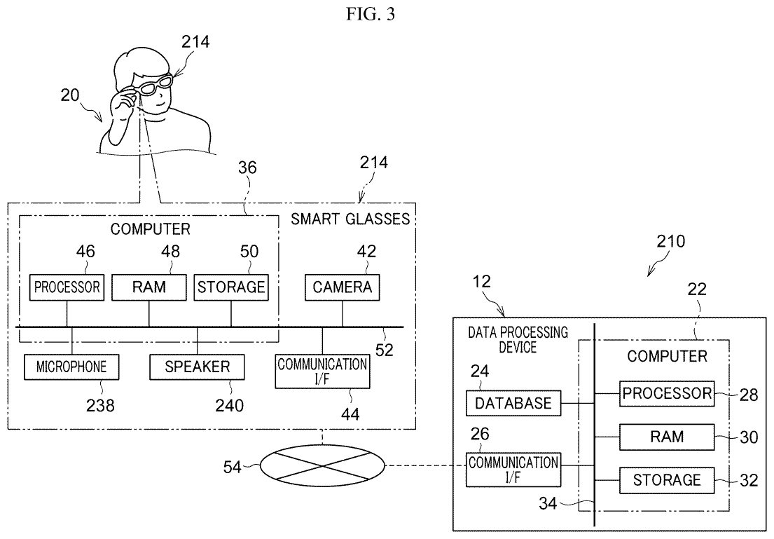

FIG. 3 illustrates an example of a configuration of a data processing system 210 according to a second exemplary embodiment.

As illustrated in FIG. 3, the data processing system 210 includes a data processing device 12 and smart glasses 214. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The smart glasses 214 include a computer 36, a microphone 238, a speaker 240, a camera 42, and a communication I/F 44. The computer 36 includes a processor 46, RAM 48, and storage 50. The processor 46, the RAM 48, and the storage 50 are connected to a bus 52. The microphone 238, the speaker 240, the camera 42, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

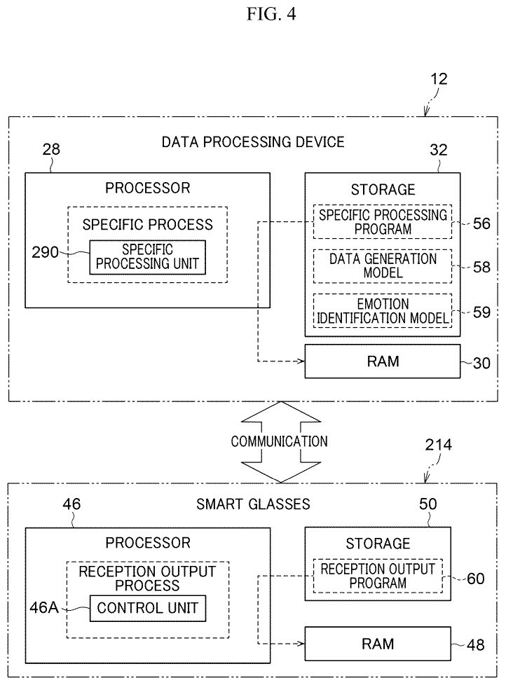

FIG. 4 illustrates an example of relevant functions of the data processing device 12 and the smart glasses 214. As illustrated in FIG. 4, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290. The specific processing unit 290 uses the emotion identification model 59 to estimate an emotion of a user, and is able to perform the specific processing using the user emotion. In an emotion estimation function (emotion identification function) that uses the emotion identification model 59, various estimations, predictions, and the like are performed related to emotions of the user, include estimating and predicting the emotion of the user, however, there is no limitation to such examples. Moreover, estimation and prediction of emotion also includes, for example, analyzing (parsing) emotions and the like.

Reception and output processing is performed by the processor 46 in the smart glasses 214. A reception and output program 60 is stored in the storage 50. The processor 46 reads the reception and output program 60 from the storage 50 and in the RAM 48 executes the read reception and output program 60. The reception and output processing is implemented by the processor 46 operating as the control unit 46A according to the reception and output program 60 executed in the RAM 48. Note that a configuration may be adopted in which the smart glasses 214 include a data generation model and an emotion identification model similar to the data generation model 58 and the emotion identification model 59, and processing similar to the specific processing unit 290 is performed using these models.

Next, description follows regarding the specific processing by the specific processing unit 290 of the data processing device 12. The units of the system described below are implemented by the data processing device 12 and the smart glasses 214. In the following description the data processing device 12 is called a “server”, and the smart glasses 214 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the smart glasses 214. The control unit 46A in the smart glasses 214 outputs the specific processing result to the speaker 240. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network. The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the smart glasses 214, the processing may be executed by a specific processing unit 290 of the data processing device 12 and a control unit 46A of the smart glasses 214. Moreover, the specific processing unit 290 of the data processing device 12 acquires and collects information needed for processing from the smart glasses 214 or from an external device or the like, and the smart glasses 214 acquires and collects information needed for processing from the data processing device 12 or from an external device or the like.

For example, the collection unit is implemented by the control unit 46A of the smart glasses 214 and/or by the specific processing unit 290 of the data processing device 12. For example, an acquisition unit acquires number-of-steps data using the camera 42 and/or the communication I/F 44 of the smart glasses 214, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 of the smart glasses 214 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the smart glasses 214.

### Third Exemplary Embodiment

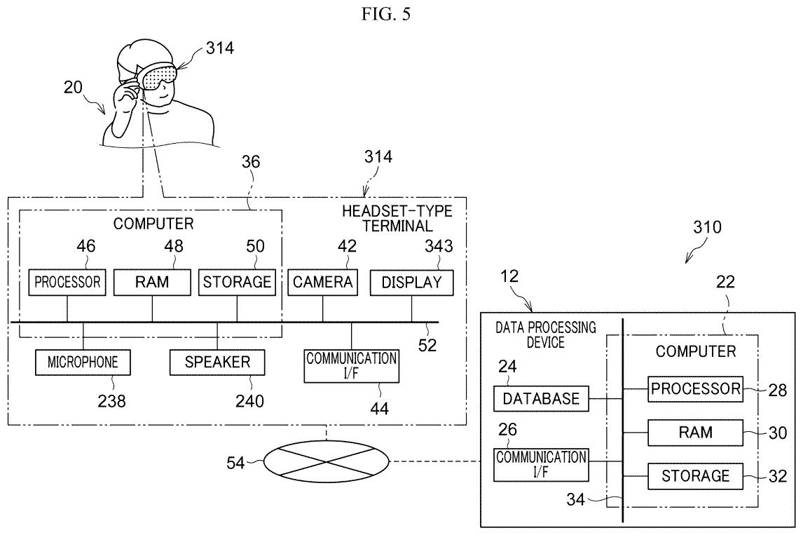

FIG. 5 illustrates an example of a configuration of a data processing system 310 according to a third exemplary embodiment.

As illustrated in FIG. 5, the data processing system 310 includes a data processing device 12 and a headset-type terminal 314. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The headset-type terminal 314 includes a computer 36, a microphone 238, a speaker 240, a camera 42, a communication I/F 44, and a display 343. The computer 36 includes a processor 46, RAM 48, and storage 50. The processor 46, the RAM 48, and the storage 50 are connected to a bus 52. The microphone 238, the speaker 240, the camera 42, the display 343, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the user 20 (for example, an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

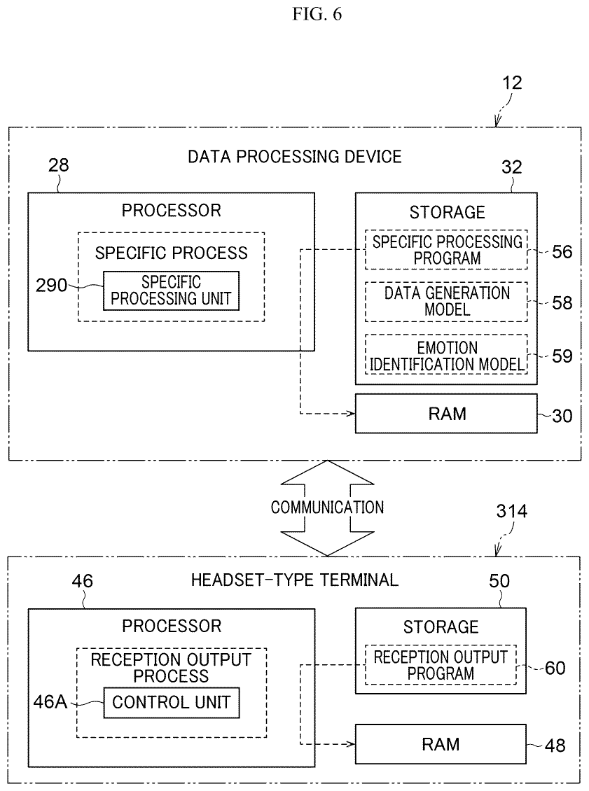

FIG. 6 illustrates an example of relevant functions of the data processing device 12 and the headset-type terminal 314. As illustrated in FIG. 6, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the headset-type terminal 314. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the headset-type terminal 314. In the following description the data processing device 12 is called a “server”, and the headset-type terminal 314 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the headset-type terminal 314. In the headset-type terminal 314, the control unit 46A outputs the result of the specific processing to the speaker 240 and the display 343. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative Als such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the headset-type terminal 314, the processing may be executed by a specific processing unit 290 of the data processing device 12 and a control unit 46A of the headset-type terminal 314. Moreover, the specific processing unit 290 of the data processing device 12 acquires and collects information needed for processing from the headset-type terminal 314 or from an external device or the like, and the headset-type terminal 314 acquires and collects information needed for processing from the data processing device 12 or from an external device or the like.

For example, the collection unit is implemented by the control unit 46A of the headset-type terminal 314 and/or by the specific processing unit 290 of the data processing device 12. For example, an acquisition unit acquires number-of-steps data using the camera 42 and/or the communication I/F 44 of the headset-type terminal 314, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the display 343 of the headset-type terminal 314 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the headset-type terminal 314.

### Fourth Exemplary Embodiment

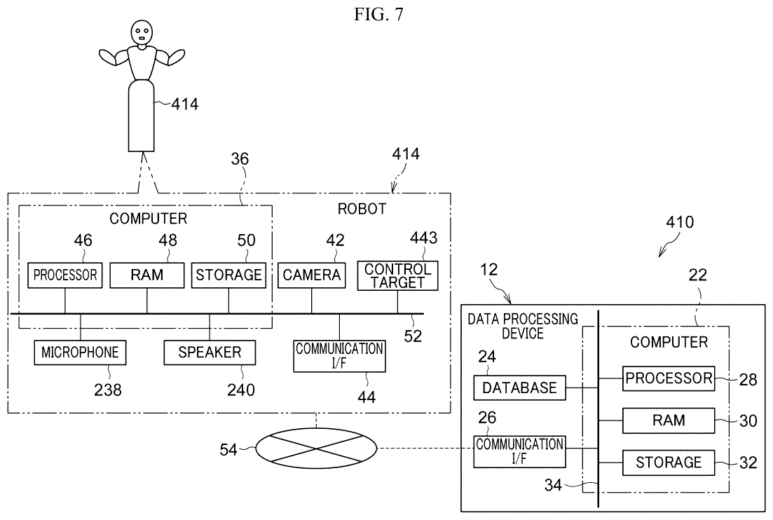

FIG. 7 illustrates an example of a configuration of a data processing system 410 according to a fourth exemplary embodiment

As illustrated in FIG. 7, the data processing system 410 includes a data processing device 12 and a robot 414. A server is an example of the data processing device 12.

The data processing device 12 includes a computer 22, a database 24, and a communication I/F 26. The computer 22 is an example of a “computer” according to technology disclosed herein. The computer 22 includes a processor 28, RAM 30, and storage 32. The processor 28, the RAM 30, and the storage 32 are connected to a bus 34. The database 24 and the communication I/F 26 are also connected to the bus 34. The communication I/F 26 is connected to a network 54. Examples of the network 54 include a Wide Area Network (WAN) and/or a local area network (LAN).

The robot 414 includes a computer 36, a microphone 238, a speaker 240, a camera 42, a communication I/F 44, and a control target 443. The computer 36 includes a processor 46, RAM 48, and storage 50. The processor 46, the RAM 48, and the storage 50 are connected to a bus 52. The microphone 238, the speaker 240, the camera 42, the control target 443, and the communication I/F 44 are also connected to the bus 52.

The microphone 238 receives an instruction or the like from a user 20 by receiving speech uttered by the user 20. The microphone 238 captures the speech uttered by the user 20, converts the captured speech into audio data, and outputs the audio data to the processor 46. The speaker 240 outputs audio under instruction from the processor 46.

The camera 42 is a compact digital camera installed with an optical system such as a lens, an aperture, a shutter, and the like, and with an imaging device such as a complementary metal-oxide semiconductor (CMOS) image sensor or a charge coupled device (CCD) image sensor or the like. The camera 42 images the surroundings of the robot 414 (for example, with an imaging range defined by an angle of view equivalent to the width of visual field of an ordinary healthy subject).

The communication I/F 44 is connected to the network 54. The communication I/F 44 and the communication I/F 26 perform the role of exchanging various information between the processor 46 and the processor 28 over the network 54. The exchange of various information between the processor 46 and the processor 28 is performed in a secure state using the communication I/F 44 and the communication I/F 26.

The control target 443 includes a display device, eye LEDs, and motors to drive arms, hands, feet, and the like. The posture and gesture of the robot 414 are controlled by controlling the motors of the arms, hands, feet, and the like. Part of an emotion of the robot 414 can be expressed by controlling these motors. Moreover, a facial expression of the robot 414 can be represented by controlling an illumination state of the eye LEDs of the robot 414.

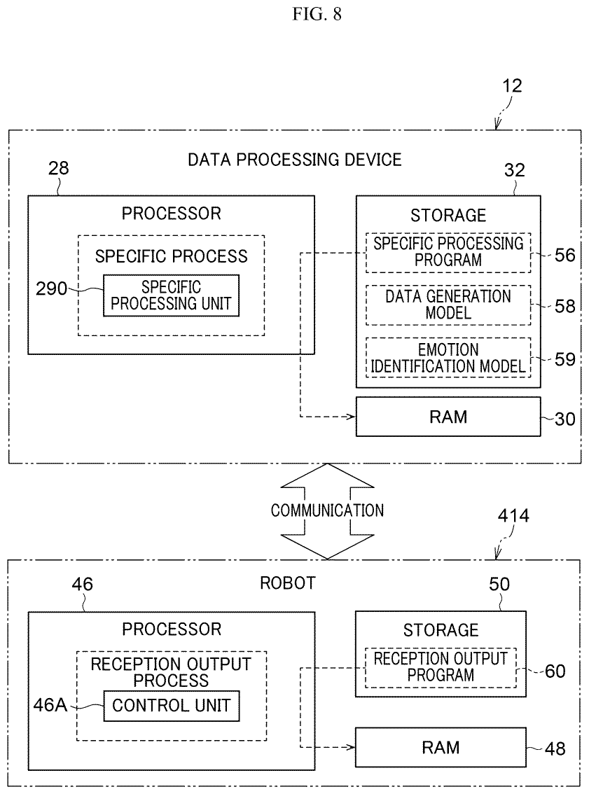

FIG. 8 illustrates an example of relevant functions of the data processing device 12 and the robot 414. As illustrated in FIG. 8, specific processing is performed by the processor 28 in the data processing device 12. A specific processing program 56 is stored in the storage 32.

The specific processing program 56 is an example of a “program” according to technology disclosed herein. The processor 28 reads the specific processing program 56 from the storage 32, and in the RAM 30 executes the read specific processing program 56. The specific processing is implemented by the processor 28 operating as the specific processing unit 290 according to the specific processing program 56 executed in the RAM 30.

The data generation model 58 and the emotion identification model 59 are stored in the storage 32. The data generation model 58 and the emotion identification model 59 are employed by the specific processing unit 290.

Reception and output processing is performed by the processor 46 in the robot 414. A reception and output program 60 is stored in the storage 50. The processor 46 reads the reception and output program 60 from the storage 50, and in the RAM 48 executes the read reception and output program 60. The reception and output processing is implemented by the processor 46 operating as the control unit 46A according to the reception and output program 60 executed in the RAM 48.

Next, description follows regarding the specific processing by the specific processing unit 290 of the data processing device 12. The units of the system described below are implemented by the data processing device 12 and the robot 414. In the following description the data processing device 12 is called a “server”, and the robot 414 is called a “terminal”.

### Example 1

Explanation of flow will be omitted due to being similar to a flow of the specific processing in Example 1 as described in the first exemplary embodiment above.

### Application Example 1

Explanation of flow will be omitted due to being similar to a flow of the specific processing in Application Example 1 as described in the first exemplary embodiment above.

### Example 2

Explanation of flow will be omitted due to being similar to a flow of the specific processing in Example 2 as described in the first exemplary embodiment above.

### Application Example 2

Explanation of flow will be omitted due to being similar to a flow of the specific processing in Application Example 2 as described in the first exemplary embodiment above.

The specific processing unit 290 transmits a result of the specific processing to the robot 414. In the robot 414, the control unit 46A outputs the result of the specific processing to the speaker 240 and the control target 443. The microphone 238 acquires audio representing user input in response to the specific processing result. The control unit 46A transmits audio data representing the user input as acquired by the microphone 238 to the data processing device 12. The specific processing unit 290 in the data processing device 12 acquires the audio data.

The data generation model 58 is a so-called generative artificial intelligence (AI). Examples of the data generation model 58 include generative AIs such as ChatGPT (registered trademark) (Internet search <URL: https://openai.com/blog/chatgpt>) and the like. The data generation model 58 is obtained by performing deep learning with a neural network.

The data generation model 58 is input with a prompt including an instruction, and is input with inference data such as audio data representing speech, text data representing text, image data representing images (for example, still image data or video data), and the like. The data generation model 58 takes the input inference data, performs inference according to the instruction indicated in the prompt, and outputs an inference result in one or more data format from out of audio data, text data, image data, or the like. The data generation model 58 includes, for example, a text generative AI, an image generative AI, a multimodal generative AI, or the like. Reference here to inference indicates, for example, analysis, classification, prediction, and/or abstraction etc. The specific processing unit 290 performs the specific processing referred to above while using the data generation model 58. The data generation model 58 may be a model fine-tuned so as to output an inference result from a prompt not including an instruction, and in such cases the data generation model 58 is able to output an inference result from the prompt not including an instruction. There are plural types of the data generation model 58 included in the data processing device 12 or the like, and the data generation models 58 include an AI other than a generative AI. An AI other than a generative AI is, for example, a linear regression, a logistic regression, a decision tree, a random forest, a support vector machine (SVM), a k-means clustering, a convolutional neural network (CNN), a recurrent neural network (RNN), a generative adversarial network (GAN), a naïve Bayes, or the like and is capable of performing various processing, however there is no limitation to such examples. The AI may be an AI agent. Moreover, when the processing of each of the units mentioned above is performed by an AI, this processing is partly or entirely performed by the AI, however there is no limitation to such examples. Moreover, processing executed by an AI including a generative AI may be switched to rule-based processing, and rule-based processing may be switched to processing executed by an AI including a generative AI.

Although the processing by the data processing system 10 described above is executed by the specific processing unit 290 of the data processing device 12 or by the control unit 46A of the robot 414, the processing may be executed by a specific processing unit 290 of the data processing device 12 and a control unit 46A of the robot 414. Moreover, the specific processing unit 290 of the data processing device 12 acquires and collects information needed for processing from the robot 414 or from an external device or the like, and the robot 414 acquires and collects information needed for processing from the data processing device 12 or from an external device or the like.

For example, the collection unit is implemented by the control unit 46A of the robot 414 and/or by the specific processing unit 290 of the data processing device 12. For example, an acquisition unit acquires number-of-steps data using the camera 42 and/or the communication I/F 44 of the robot 414, and the number-of-steps data is processed by the specific processing unit 290 of the data processing device 12. For example, an analysis unit implemented by the specific processing unit 290 of the data processing device 12 analyzes data from the collection unit and the acquisition unit. For example, a generation unit implemented by the specific processing unit 290 of the data processing device 12 generates a cooking menu using a generative AI. For example, a supply unit implemented by the speaker 240 and the control target 443 of the robot 414 and/or the specific processing unit 290 of the data processing device 12 supplies the generated cooking menu to the user. Correspondence relationships of each unit to devices and control units are not limited to the examples described above, and various modifications thereof are possible.

The above exemplary embodiment gives an implementation example in which the specific processing is performed by the data processing device 12, however technology disclosed herein is not limited thereto, and the specific processing may be performed by the robot 414.

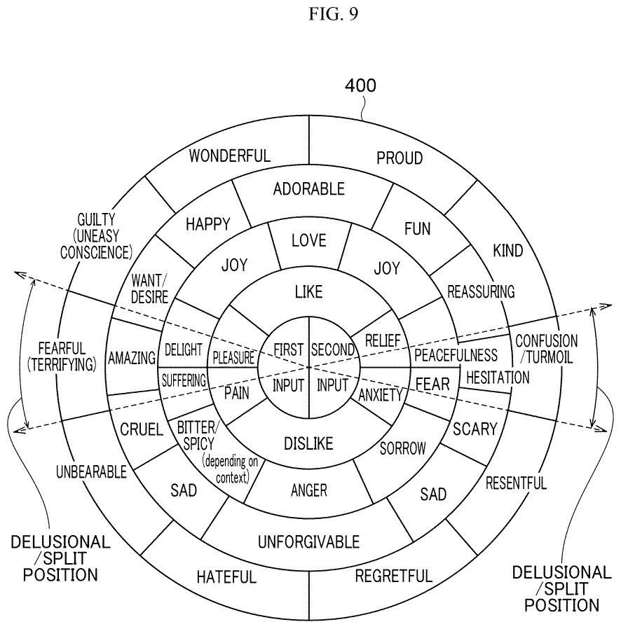

Note that the emotion identification model 59 serves as an emotion engine, and may decide the emotion of a user according to a specific mapping. Specifically, the emotion identification model 59 may decide the emotion of a user according to an emotion map (see FIG. 9) that is a specific mapping. Moreover, the emotion identification model 59 may also decide the emotion of the robot similarly, and the specific processing unit 290 may be configured so as to perform the specific processing using the emotion of the robot.

FIG. 9 is a diagram illustrating an emotion map 400 mapping plural emotions. In the emotion map 400, emotions are arranged in concentric circles that radiate out from the center. Primitive states of emotion are arranged nearer to the center of the concentric circles. Emotions expressing states and actions generated from states of mind are arranged further toward the outside of the concentric circles. Emotions are defined as including both affect and mental states. Emotions generated from reactions occurring in the brain are generally arranged at the left side of the concentric circles. Emotions induced by situational assessment are generally arranged at the right side of the concentric circles. Emotions generated from reactions occurring in the brain that are also emotions induced by situational assessment are generally arranged toward the top and toward the bottom of the concentric circles. Moreover, emotions of “euphoria” are arranged at the upper side of the concentric circles, and emotions of “dysphoria” are arranged at the lower side of the concentric circles. Plural emotions are accordingly mapped in this manner in the emotion map 400 based on a structure giving rise to emotions, and emotions that readily occur at the same time are mapped close to each other.

An example of such emotions is a distribution of emotions in the direction of 3 o'clock on the emotion map 400, generally around a boundary between relief and anxiety. Situational awareness dominates over internal sensations in the right half of the emotion map 400, with an impression of calm.

The inside of the emotion map 400 represents feelings, and the outside of the emotion map 400 represents actions, and so emotions further toward the outside of the emotion map 400 are more visible (are expressed by actions).

Human emotions are based on various balances, such as posture and blood sugar value balances, with a state of dysphoria being exhibited when these balances are far from ideal and a state of euphoria being exhibited when these balances are near to ideal. Even in a robot, a car, a motorbike, or the like, emotions can be thought of as being based on various balances such as orientation and remaining battery balances, with a state called dysphoria being exhibited when these balances are far from ideal and a state called euphoria being exhibited when these balances are near to ideal. An emotion map may, for example, be generated based on the emotion map of Dr. Mitsuyoshi (PhD Dissertation https://ci.nii.ac.jp/naid/500000375379: “Research on the phonetic recognition of feelings and a system for emotional physiological brain signal analysis”, Tokushima University). Emotions belonging to an area called “reaction” where feeling dominates are arranged in the left half of the emotion map. Moreover, emotions belonging to an area called “situation” where situational awareness dominates are arranged in the right half of the emotion map.

There are two types of emotion that facilitate leaning in an emotion map. One is an emotion in the vicinity of the center of negative “penitence” and “reflection” on the situational side. In other words, sometimes a negative “emotion” such as “I don't want to feel this way ever again” and “I don't want to be chided again” is experienced in a robot. Another is a positive emotion in the area of “desire” on the reaction side. In other words, there are times when a positive feeling such as “desire more” and “want to know more” is experienced.

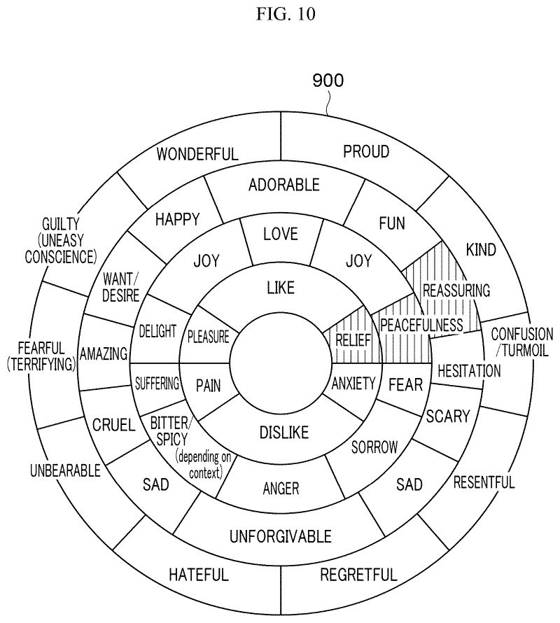

In the emotion identification model 59, user input is input to a pre-trained neural network, and emotion values indicating emotions shown on the emotion map 400 are acquired and the emotions of the user are decided. This neural network is pre-trained based on plural training data sets that each combine a user input with an emotion value indicating an emotion shown on the emotion map 400. The neural network is also trained such that emotions arranged close to each other have values that are close to each other, as in an emotion map 900 illustrated in FIG. 10. In FIG. 10 the plural emotions of “relief”, “peaceful”, and “reassured” are indicated as an example of close emotion values.

Although the system according to the present disclosure has been described mainly as functions of the data processing device 12, the system according to the present disclosure is not limited to being implemented in a server. The system according to the present disclosure may be implemented as a general information processing system. The present disclosure may, for example, be implemented by a software program operating on a personal computer, and may be implemented by an application operating on a smartphone or the like. The method according to the present disclosure may also be supplied to a user in the form of Software as a Service (SaaS).

Although in the exemplary embodiments described above examples are given of embodiments in which the specific processing is performed by a single computer 22, technology disclosed herein is not limited thereto, and distributed processing may be performed for the specific processing, with the specific processing distributed across plural computers including the computer 22. For example, the data generation model 58 may be provided in a device external to the data processing device 12, such that data generation in response to input data is performed in the external device.

Although in the exemplary embodiments described above examples are described of embodiments in which the specific processing program 56 is stored in the storage 32, the technology disclosed herein is not limited thereto. For example, the specific processing program 56 may be stored on a portable, non-transitory, computer readable, storage medium, such as universal serial bus (USB) memory or the like. The specific processing program 56 stored on the non-transitory storage medium is then installed on the computer 22 of the data processing device 12. The processor 28 then executes the specific processing according to the specific processing program 56.

Moreover, the specific processing program 56 may be stored on a storage device, such as a server connected to the data processing device 12 over the network 54, with the specific processing program 56 then being downloaded in response to a request from the data processing device 12 and installed on the computer 22.

Note that there is no need to store the entire specific processing program 56 on the storage device, such as a server connected to the data processing device 12 over the network 54, or to store the entire specific processing program 56 on the storage 32, and part of the specific processing program 56 may be stored thereon.

Hardware resources for executing the specific processing may use various processors as listed below. Examples of processors include, for example, a CPU that is a general-purpose processor that functions as a hardware resource to execute the specific processing by executing software, namely a program. Moreover, the processor may, for example, be a dedicated electronic circuit that is a processor having a circuit configuration custom designed for executing the specific processing, such as a field-programmable gate array (FPGA), a programmable logic device (PLD), or an application specific integrated circuit (ASIC). Memory is inbuilt or connected to each of these processors, and the specific processing is executed by each of these processors using the memory.

The hardware resource that executes the specific processing may be configured from one of these various processors, or may be configured from a combination of two or more processors of the same or different type (for example, a combination of plural FPGAs, or a combination of a CPU and a FPGA). The hardware resource executing the specific processing may be a single processor.

Examples of configurations of a single processor include, firstly, a configuration of a single processor resulting from combining one or more CPU and software, in an embodiment in which this processor functions as the hardware resource for executing the specific processing. Secondly, as typified by a System-on-chip (SOC) or the like, there is also an embodiment that uses a processor realized by a single IC chip to function as an overall system including plural hardware resources for executing the specific processing. Adopting such an approach means that the specific processing is realized using one or more of the various processors described above as hardware resource.

Furthermore, more specifically, an electrical circuit that combines circuit elements such as semiconductor elements or the like may be employed as a hardware structure of these various processors. The specific processing is merely an example thereof. This means that obviously redundant steps may be omitted, new steps may be added, and the processing sequence may be swapped around within a range not departing from the spirit of the present disclosure.

The described content and drawing content illustrated above are a detailed description of parts according to the present disclosure, and are merely examples of the present disclosure. For example, description related to the above configuration, function, operation, and advantageous effects is a description related to examples of the configuration, function, operation, and advantageous effects of parts according to the present disclosure. This means that obviously redundant parts may be eliminated, new elements may be added, and switching around may be performed on the described content and drawing content illustrated above within a range not departing from the spirit of the present disclosure. Moreover, to avoid misunderstanding and to facilitate understanding of parts according to the present disclosure, description related to common knowledge in the art and the like not particularly needing description to enable implementation of the present disclosure is omitted in the described content and drawing content illustrated as described above.

All publications, patent applications and technical standards mentioned in the present specification are incorporated by reference in the present specification to the same extent as if each individual publication, patent application, or technical standard was specifically and individually indicated to be incorporated by reference.

Note that, regarding the above description, the following supplementary notes are further disclosed.

### Example 1

### (Supplementary 1)

A system comprising a processor, a storage device, and a user terminal,
wherein the processor is configured to
acquire, from the user terminal, attribute information and image information regarding an article possessed by a user, the attribute information including at least category information, color information, material information, and mark information, and to structure the acquired attribute information and the image information as structured data representing the article, and
store the structured data in a plurality of storage areas of the storage device having a relational database management function, the storing including dividing and storing the structured data by the category information, the color information, the material information, and the mark information, and, on the basis of a search condition designated from the user terminal, searching the storage device for the attribute information and the image information regarding the article and outputting a search result as presentation data to the user terminal, and
acquire, from the user terminal, command information including a natural language prompt sentence, and supply, to a generative artificial intelligence model, input information including the prompt sentence and the structured data stored in the storage device regarding the article possessed by the user, so as to cause the generative artificial intelligence model to perform inference processing to generate a clothing coordination proposal, and associate the clothing coordination proposal obtained from the generative artificial intelligence model with the attribute information and the image information of the article possessed by the user and notify the clothing coordination proposal to the user terminal as display data, and
include, in the input information supplied to the generative artificial intelligence model, weather forecast information acquired from a weather information acquisition device and information regarding an emotional state of the user acquired from a user state estimation device, so as to cause the generative artificial intelligence model to generate a clothing coordination proposal that conforms to weather conditions for a day and the emotional state of the user, and
sequentially input, to the generative artificial intelligence model, data including a past selection history and evaluation information of the user, so that the generative artificial intelligence model learns feature information representing a preference tendency and a usage tendency of the user, generate an internal prompt sentence configured to instruct the generative artificial intelligence model to perform a personalized proposal of the clothing coordination proposal for each user, and include the internal prompt sentence in the input information supplied to the generative artificial intelligence model, and
acquire season information, trend information, position information, and sales information, generate an internal prompt sentence configured to instruct the generative artificial intelligence model to present purchase information, route information, and layout information corresponding to an article not possessed by the user and included in the clothing coordination proposal, and output, to the user terminal, link information representing the purchase information and map information indicating a position of the article in a facility.

### (Supplementary 2)

The system according to supplementary 1,
wherein the processor is configured to cause the user terminal to generate the structured data by combining image data of the article acquired by an imaging device of the user terminal with the category information, the color information, the material information, and the mark information input by the user on the user terminal, and to cause the user terminal to transmit the structured data to the processor in a predetermined data interchange format so as to execute a registration process and an update process of the article.

### (Supplementary 3)

The system according to supplementary 1,
wherein the processor is configured to analyze, in the clothing coordination proposal obtained from the generative artificial intelligence model, an article type and an attribute description for each article element, perform an association process between the article type and the attribute description and the attribute information of the article possessed by the user and stored in the storage device, specify, from among the articles possessed by the user, an article corresponding to each article element in the clothing coordination proposal, and output, to the user terminal, identifier information and image information assigned to each specified article.

### Application Example 1

### (Supplementary 1)

A system comprising a processor,
wherein the processor is configured to
store information on personal belongings possessed by a user and classify and manage the personal belongings,
acquire weather forecast information from an external information source and analyze the weather forecast information to identify weather conditions corresponding to a predetermined time and a predetermined region,
acquire merchandise information on a product being browsed in a virtual sales environment in response to an operation by the user and record the merchandise information in association with the user,
analyze an emotional state of the user and learn preference tendencies of the user on the basis of an operation history and a response history of the user,
generate a prompt sentence to be input to a generative AI model on the basis of the weather forecast information, the information on the personal belongings, the merchandise information, and the preference tendencies,
input the prompt sentence to the generative AI model and cause the generative AI model to execute text generation processing so as to generate outfit proposal information that is adapted to the weather conditions and the emotional state of the user and that combines the personal belongings possessed by the user and the product in the virtual sales environment, identify each personal belonging and each product included in the outfit proposal information and associate the identified personal belongings and products with image information and acquisition destination information,
transmit the outfit proposal information to a user terminal and cause the outfit proposal information to be displayed on the user terminal,
acquire response information relating to selection operations and purchase operations from the user terminal and record the response information as a history, and update contents of the prompt sentence on the basis of the history and reflect the updated contents in generation of outfit proposal information in a subsequent process.

### (Supplementary 2)

The system according to supplementary 1,
wherein the processor is configured to
add, to the prompt sentence, preference information summarizing an outfit style preferred by the user, favorable color combinations, and preferred types of personal belongings on the basis of the preference tendencies and the history, and to instruct the generative AI model to generate personalized outfit proposal information on the basis of the preference information.

### (Supplementary 3)

The system according to supplementary 1,
wherein the processor is configured to
add, to the prompt sentence, seasonality information based on the weather forecast information and calendar information, include trend information acquired from a trend information source in the prompt sentence, and generate purchase information and guidance information on a position of the product in the virtual sales environment on the basis of the merchandise information, and to instruct the generative AI model to output outfit proposal information and purchase guidance information in accordance with the seasonality information, the trend information, and the purchase information.

### Example 2

### (Supplementary 1)

A system comprising a processor,
wherein the processor is configured to
store and manage garment article information registered by a user as storage information, acquire user location information and, on the basis of the user location information, acquire meteorological information from an external information provision apparatus and store the meteorological information as storage information,
generate a prompt sentence for input to a generative AI model on the basis of the garment article information and the meteorological information, and transmit the prompt sentence to the generative AI model,
receive outfit proposal information output from the generative AI model in response to the prompt sentence and analyze the outfit proposal information to convert the outfit proposal information into component information,
generate proposed outfit information including upper-body article information, lower-body article information, footwear article information, and accessory article information on the basis of the component information, and transmit the proposed outfit information to a terminal device, and
generate control information that enables the proposed outfit information to be presented as display information on the terminal device.

### (Supplementary 2)

The system according to supplementary 1,
wherein the processor is configured to
acquire user preference information and evaluation information for past proposals from the storage information, and generate the prompt sentence including instruction content that reflects the user preference information and the evaluation information so that the generative AI model performs personalized proposals on the basis of the garment article information and the meteorological information.

### (Supplementary 3)

The system according to supplementary 1,
wherein the processor is configured to
acquire time information, calendar information, trend information, and purchase-related information from the storage information, and generate the prompt sentence including instruction content that causes the generative AI model to generate outfit proposals taking into account seasonality and trend characteristics, and to generate purchase candidate information for necessary articles and sales-location guidance information, on the basis of the garment article information and the meteorological information.

### Application Example 2

### (Supplementary 1)

A system comprising a processor and a memory,
wherein the processor is configured to
store and update, in the memory, wearer-related article information representing articles to be worn possessed by a user,
acquire weather forecast information from an external information providing apparatus and hold the acquired information as weather condition data,
calculate and accumulate user psychological state information based on user input and information obtained from an imaging apparatus and a voice acquiring apparatus,
dynamically generate a prompt sentence as an instruction text for a generative AI model, the prompt sentence being generated on the basis of the wearer-related article information, the weather condition data, the psychological state information, and preference history information of the user, and transmit the prompt sentence to the generative AI model, receive output text from the generative AI model, analyze the output text, and convert the analyzed output text into structured proposal data associated with the wearer-related article information and merchandise information,
generate, on the basis of the structured proposal data, an outfit proposal adapted to a weather condition and a psychological state of a current day of the user, and output display data representing the outfit proposal to a user information processing terminal,
add acquisition procedure information to articles included in the outfit proposal on the basis of the merchandise information and transmit the acquisition procedure information to the user information processing terminal,
receive selection result information and evaluation information of the user transmitted from the user information processing terminal, and accumulate the selection result information and the evaluation information in the memory as the preference history information, and
update contents of generation of the prompt sentence and a utilization method of the output of the generative AI model by using the preference history information, and perform individual optimization of subsequent outfit proposals.

### (Supplementary 2)

The system according to supplementary 1,
wherein the processor is configured to calculate preference feature information of the user from at least one of outfit selection history, evaluation information, purchase history, and usage frequency information, and add a sentence expression including the preference feature information to the prompt sentence so as to emphasize individual proposals by the generative AI model.

### (Supplementary 3)

The system according to supplementary 1,
wherein the processor is configured to incorporate, into the prompt sentence, seasonal information based on calendar information and trend information acquired from an external trend information providing apparatus, in combination with the weather condition data and the psychological state information, and to configure the prompt sentence so that acquisition procedure information and sales location guidance information based on the merchandise information and position information of the user are included as output targets of the generative AI model.

What is claimed is:

1. A system comprising:
a communication interface coupled to a packet-switched network;
a storage device; and
circuitry configured to:
store and manage, in the storage device, item attribute data registered by a user via a terminal device, the item attribute data comprising at least category data, color data, material data, and classification mark data organized in a plurality of storage areas divided by attribute;
acquire environmental condition data from an external information provision apparatus via the communication interface, and store the environmental condition data in the storage device;
analyze a psychological state of the user based on at least one of input text data, image data from an imaging apparatus, and voice data from a voice acquisition apparatus to generate psychological state information;
generate a prompt sentence for a generative neural network model based on the item attribute data, the environmental condition data, and the psychological state information, input the prompt sentence to the generative neural network model, and acquire output data from the generative neural network model;
analyze the output data to convert the output data into structured proposal data, and associate the structured proposal data with the item attribute data stored in the storage device to identify matching stored items; and
transmit, via the communication interface, display data comprising identifiers of the matching stored items and the structured proposal data to the terminal device.

2. The system according to claim 1, wherein the circuitry is further configured to:
acquire preference history data from the storage device, and generate an internal prompt sentence based on the preference history data to instruct the generative neural network model to perform personalized inference reflecting learned usage tendencies of the user.

3. The system according to claim 2, wherein the circuitry receives selection result data and evaluation data from the terminal device, accumulates the selection result data and the evaluation data in the storage device as the preference history data, and updates a generation condition of the prompt sentence based on the preference history data.

4. The system according to claim 3, wherein the circuitry dynamically adjusts a weighting parameter applied to the psychological state information in the prompt sentence based on a trend computed from a temporal sequence of the evaluation data.

5. The system according to claim 4, wherein the item attribute data is structured as normalized data records including at least a category identifier, a color value represented in a numerical color space, and a material classification code, and the circuitry performs attribute-level similarity computation between the structured proposal data and the normalized data records to identify the matching stored items.

6. The system according to claim 5, wherein the circuitry computes a coordination compatibility score for each combination of identified stored items by evaluating inter-item attribute relationships stored in a compatibility matrix in the storage device.

7. The system according to claim 1, wherein the circuitry is further configured to:
acquire temporal context data comprising at least one of season information and trend information, and incorporate the temporal context data into the prompt sentence to instruct the generative neural network model to generate temporally adapted proposal data.

8. The system according to claim 7, wherein the circuitry identifies, from the structured proposal data, item types not present in the item attribute data stored in the storage device, and generates acquisition procedure information comprising at least a link to an external resource for obtaining the identified item types.

9. The system according to claim 8, wherein the circuitry acquires position information of the user from the terminal device, and generates navigation data comprising route information to a physical location associated with the identified item types based on the position information and location data stored in the storage device.

10. The system according to claim 9, wherein the circuitry acquires sales information from an external apparatus via the communication interface, and incorporates the sales information into the acquisition procedure information to prioritize available sources based on proximity and availability parameters.

11. The system according to claim 1, wherein the circuitry is further configured to:
generate the prompt sentence by combining a template data structure with the item attribute data, the environmental condition data, and the psychological state information, wherein the template data structure specifies a structured instruction format for the generative neural network model.

12. The system according to claim 11, wherein the circuitry selects the template data structure from among a plurality of stored template data structures based on a classification of the psychological state information and a category distribution of the item attribute data.

13. The system according to claim 12, wherein the circuitry parses the output data from the generative neural network model by applying pattern matching to extract component-level identifiers corresponding to a plurality of item categories, and maps each component-level identifier to a stored item record in the storage device.

14. The system according to claim 1, wherein the circuitry is further configured to:
train an anomaly detection model on the preference history data representing normal selection patterns, compute a reconstruction error for newly received evaluation data using the anomaly detection model, and generate a notification when the reconstruction error exceeds a predetermined threshold indicating a shift in user preference patterns.

15. The system according to claim 14, wherein the circuitry, upon generating the notification, resets the weighting parameters applied to the preference history data in the prompt sentence generation and initiates a relearning phase using a most recent subset of the evaluation data.

16. The system according to claim 1, wherein the circuitry is further configured to:
generate a plurality of candidate prompt sentences varying in emphasis among the environmental condition data, the psychological state information, and the preference history data, input each candidate prompt sentence to the generative neural network model, score each resulting output data based on a diversity metric and a relevance metric, and select a highest-scoring output as the structured proposal data.

17. The system according to claim 1, wherein the psychological state information comprises a vector representation of emotion classification scores derived from multimodal analysis of the input text data, the image data, and the voice data, and the circuitry normalizes the emotion classification scores to a common scale prior to inclusion in the prompt sentence.

18. A system comprising:
a communication interface coupled to a packet-switched network;
a storage device; and
circuitry configured to:
store and manage, in the storage device, item attribute data comprising normalized data records including category identifiers, color values, material classification codes, and classification mark data associated with items registered by a user;
acquire environmental condition data from an external information provision apparatus via the communication interface, and analyze a psychological state of the user based on at least one of input text data, image data, and voice data to generate psychological state information comprising emotion classification scores;
generate a prompt sentence for a generative neural network model by combining the item attribute data, the environmental condition data, the psychological state information, and preference history data accumulated from prior user interactions, input the prompt sentence to the generative neural network model, and acquire output data;
analyze the output data to convert the output data into structured proposal data, associate the structured proposal data with the item attribute data to identify matching stored items, and identify item types not present in the storage device to generate acquisition procedure information;
transmit, via the communication interface, display data comprising identifiers of the matching stored items, the structured proposal data, and the acquisition procedure information to a terminal device; and
receive selection result data and evaluation data from the terminal device, store the selection result data and the evaluation data as the preference history data, and update a generation condition of the prompt sentence based on the preference history data.

19. The system according to claim 18, wherein the circuitry acquires position information of the user from the terminal device, and generates navigation data comprising route information to a physical location associated with the identified item types based on the position information and location data stored in the storage device.

20. A method comprising:
storing and managing, in a storage device, item attribute data registered by a user via a terminal device, the item attribute data comprising at least category data, color data, material data, and classification mark data organized in a plurality of storage areas divided by attribute;
acquiring environmental condition data from an external information provision apparatus via a communication interface coupled to a packet-switched network, and storing the environmental condition data in the storage device;
analyzing a psychological state of the user based on at least one of input text data, image data, and voice data to generate psychological state information;
generating a prompt sentence for a generative neural network model based on the item attribute data, the environmental condition data, and the psychological state information, inputting the prompt sentence to the generative neural network model, and acquiring output data from the generative neural network model;
analyzing the output data to convert the output data into structured proposal data, and associating the structured proposal data with the item attribute data stored in the storage device to identify matching stored items; and
transmitting, via the communication interface, display data comprising identifiers of the matching stored items and the structured proposal data to the terminal device.
